(19) United States
(12) Patent Application Publication
(10) Pub. No.: US 2017/0289791 A1
(43) Pub. Date: Oct. 5, 2017

(54) COMMUNICATION METHOD AND APPARATUS USING NETWORK SLICE

(71) Applicant: ELECTRONICS AND TELECOMMUNICATIONS RESEARCH INSTITUTE, Daejeon (KR)

(72) Inventors: Tae Whan YOO, Daejeon (KR); Jongtae SONG, Daejeon (KR); Pyeong Jung SONG, Daejeon (KR); Ho Young SONG, Daejeon (KR); Joon Kyung LEE, Daejeon (KR)

(21) Appl. No.: 15/478,465

(22) Filed: Apr. 4, 2017

(30) Foreign Application Priority Data
Apr. 5, 2016 (KR) 10-2016-0041949
Mar. 10, 2017 (KR) 10-2017-0030791

(51) Int. Cl. H04W 8/18; H04W 12/06; H04W 60/04; H04W 68/00; H04W 60/06; H04W 8/22; H04W 76/02

(52) U.S. Cl. CPC H04W 8/183; H04W 8/22; H04W 12/06; H04W 76/021; H04W 68/005; H04W 60/06; H04W 60/04; H04W 16/02

(57) ABSTRACT

A communication method and apparatus using a network slice. A method of performing communication on a control plane of a network system including an access network and a core network may receive an attach request from a user equipment, may perform a mutual authentication with the user equipment in response to the attach request, may retrieve a subscription profile for the user equipment in response to the attach request, when the mutual authentication is completed, and may determine a network slice for the user equipment based on the subscription profile.

### CROSS-REFERENCE TO RELATED APPLICATION(S)

This application claims the priority benefit of Korean Patent Application No. 10-2016-0041949, filed on Apr. 5, 2016, and Korean Patent Application No. 10-2017-0030791, filed on Mar. 10, 2017, in the Korean Intellectual Property Office, the disclosures of which are incorporated herein by reference for all purposes.

### BACKGROUND

### 1. Field

At least one example embodiment relates to a communication method and apparatus using a network slice, and more particularly, to a communication method and apparatus associated with network function virtualization and a future network of International Mobile Telecommunication (IMT)-2020.

### 2. Description of Related Art

Network Functions Virtualization (NFV) technology is introduced as technology for supporting the openness and virtualization of a network to build a future-oriented network and service infrastructure. The NFV technology may implement a single network service by virtually installing, combining, and executing a required network function based on traffic. Through virtualization of network functions using the NFV technology, a network service may be configured in a timely manner and may be actively controlled depending on circumstances.

### SUMMARY

At least one example embodiment may provide a network slice management function based on a lifecycle of a network slice, such as creation, change, termination, etc., of the network slice providing an end-to-end service.

At least one example embodiment may provide a dynamic service-on-demand based on a network slice.

At least one example embodiment may provide a procedure and a function that enable a user to utilize a network service through attaching to, switching between, and finally detaching from the network slices.

According to an aspect of at least one example embodiment, there is provided a communication method on a control plane of a network system including an access network and a core network, the communication method including receiving an attach request from a user equipment; performing a mutual authentication with the user equipment in response to the attach request; retrieving a subscription profile for the user equipment in response to the attach request, when the mutual authentication is completed; and determining a network slice for the user equipment based on the subscription profile.

The network slice may include at least one virtualized network function for providing an end-to-end network service to the user equipment.

The attach request may include information about a type of a service the user equipment desires to use and a capability of a user equipment, or information about a context in which a user equipment resides.

Information about the type of the service may include information about at least one of a service type the user equipment desires to use, an application service identifier, and a data network name to be connected to, and a network slice previously attached to by the user equipment.

The subscription profile may include information about a network slice allowed to the user equipment, and may include information about a default network slice when information about a type of a service the user equipment desires to use is not included in the attach request.

The communication method may further include transferring the identifiers of the determined network slices and a temporary identifier of the user equipment.

The communication method may further include transferring identifiers of the determined network slices and a temporary identifier of the user equipment to a network slice mapping function for control plane (NSLMF-CP).

The communication method may further include determining a front-end common control function (FCCF) appropriate for the user equipment based on at least one of a current status of the user equipment, a local status of the network system, and an network operator's policy.

The communication method may further include determining a network slice control function (NSLCF) based on at least one of a service type and a local policy corresponding to the user equipment in response to the attach request, when the NSLCF is not determined at an access network having received the attach request; updating a forwarding table with the determined NSLCF; and transferring the attach request to the determined NSLCF using the forwarding table.

A network slice mapping function (NSLMF) of determining a network slice instance to process a packet on the control plane transferred from the user equipment based on an identifier of the determined network slice may be provided to one of the core network, the access network, and the user equipment.

The communication method may further include receiving a control plane message, a temporary identifier of the user equipment, and an identifier of the network slice from the user equipment; and determining a network slice instance to which the control plane message is to be transferred based on the temporary identifier of the user equipment and the identifier of the network slice.

The determining of the network slice may be performed by a network slice mapping function (NSLMF) provided to one of the core network, the access network, and the user equipment.

According to an aspect of at least one example embodiment, there is provided a communication method on a control plane of a network system including an access network and a core network, the communication method including receiving a new service request from a user equipment; determining whether a currently selected network slice is capable of providing a corresponding service in response to the new service request; retrieving a subscription profile for the user equipment in response to the new service request, when the corresponding service is not provided at the currently selected network slice; adding a new network slice or changing the currently selected network slice with the new network slice based on the subscription profile; and transferring an identifier of the new network slice to the user equipment.

The changing may include determining the new network slice within a range allowed by the subscription profile in response to the new service request; and newly selecting a front-end common control function (FCCF) or a network slice mapping function (NSLMF) corresponding to the new network slice, and setting network slice information associated with the user equipment to the selected FCCF or NSLMF, and the transferring may include transferring the identifier of the newly selected network slice to the user equipment and further transferring an identifier of a changed FCCF or NSLMF in response to the change of the FCCF or the NSLMF.

The communication method may further include recognizing a change of the subscription profile for the user equipment; and paging the change of the subscription profile to the user equipment based on a recognition result.

According to an aspect of at least one example embodiment, there is provided a communication method on a control plane of a network system including an access network and a core network, the communication method including determining a detachment procedure based on a type of a service used by a user equipment and a network context and policy; detaching the user equipment from a network slice used by the user equipment according to the detachment procedure; and deleting information about the user equipment according to the detachment procedure using a network slice mapping function (NSLMF), in response to the detachment procedure being completed at the network slice.

The communication method may further include receiving a detach request from the user equipment; deleting a network slice configuration for the user equipment from the control plane of the network system in response to the detach request; and sending a response to the detach request to the user equipment in response to the network slice configuration being deleted.

The communication method may further include recognizing a unnotified detachment of the user equipment or receiving a unilateral detachment from all of the network slices used by the user equipment; and deleting a network slice configuration for the user equipment from the control plane of the network system in response to recognizing the unnotified detachment or receiving the unilateral detachment.

According to an aspect of at least one example embodiment, there is provided a communication method on a user plane of a network system including an access network and a core network, the communication method including receiving a user plane packet from a user equipment; mapping a corresponding network slice to the user plane packet; transferring the user plane packet to the network slice; and processing the user plane packet through the network slice.

The processing may include processing the user plane packet by further using a back-end shared user plane function (BSUF), when the BSUF shared between a part of or all of the network slices is present.

The communication method may further include completing a configuration of a forwarding table for the user equipment at an NSLMF provided to one of the core network, the access network, and the user equipment.

According to an aspect of at least one example embodiment, there is provided a communication method of a network system including an access network and a core network, the communication method including providing a service on-demand by selecting a network slice appropriate to the service requested from a user equipment among network slices specified for each service; configuring a service within the selected network slice to be optimized for a characteristic of the service or a user environment on the granularity of packet or service flow; and creating a new network slice to provide the service or modifying an exisiting network slice when the service requested from the user is incapable of being satisfied through the exisiting network slice due to the limitation interms of performance or coverage. The network system may include a network slice operation environment providing functional blocks that includes a network slice control apparatus and a plurality of network slices; a virtualized resource configured to execute an operation environment of the network slice; a network slice management function configured to manage a lifecycle of the network slice; a virtualized resource management function configured to manage a lifecycle of the virtualized resource; a network slice service orchestration function configured to orchestrate the network slice and to orchestrate a configuration of a resource; a network slice service business support system/operation support system (BSS/OSS) function used for the network slice to provide a business support and a network slice operation management, and a business and operation management methods for the entire network slices to a network slice provider; a network slice control portal function configured to enable the user equipment to manage a network slice; and a network slice attachment for the user equipment.

According to example embodiments, it is possible to dynamically provide a on-demand service. In detail, it is possible to reduce the lead time in configuring a global network slice and to dynamically provide a service on-demand through three types of user-customizable service providing procedures.

Also, according to example embodiments, it is possible to unify current physical networks specialized for each service into a single physical network infrastructure where multiple services can be provided through network slices.

Also, according to example embodiment, it is possible to accelerate the unification of a cloud and a network by implementing network functions in softwares.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating high-level functions of a network slicing according to an example embodiment;

FIG. 2 is a diagram illustrating an architecture of a network slice system according to an example embodiment;

FIG. 3 is a flowchart illustrating a communication method of a service using a network slice according to an example embodiment;

FIG. 4 is a diagram illustrating a functional architecture on a control plane of a network slice according to an example embodiment;

FIG. 5 illustrates an initial attachment procedure and a control message processing procedure of a network slice according to an example embodiment;

FIG. 6 illustrates a procedure of adding a network slice according to an example embodiment;

FIG. 7 illustrates a detachment procedure of a network slice according to an example embodiment;

FIG. 8 is a diagram illustrating a functional architecture on a control plane of a network slice according to another example embodiment;

FIG. 9 illustrates an initial attachment procedure and a control message processing procedure of a network slice according to another example embodiment;

FIG. 10 illustrates a procedure of adding a network slice according to another example embodiment;

FIG. 11 illustrates a detachment procedure of a network slice according to another example embodiment;

FIG. 12 is a diagram illustrating a functional architecture on a user plane of a network slice according to an example embodiment;

FIG. 13 illustrates a functional processing procedure on a user plane of a network slice according to an example embodiment;

FIG. 14 is a diagram illustrating an example of a functional architecture when the functions of FIG. 4 are deployed in a network system according to an example embodiment;

FIG. 15 illustrates an initial attachment procedure in the functional architecture of FIG. 14 according to an example embodiment;

FIG. 16 is a diagram illustrating an example of a functional architecture when the functions of FIG. 8 are deployed in a network system according to an example embodiment;

FIG. 17 illustrates an initial attachment procedure in the functional architecture of FIG. 16 according to an example embodiment;

FIG. 18 is a diagram illustrating another example of the functional architecture when the functions of FIG. 8 are deployed in the network system according to an example embodiment;

FIG. 19 illustrates an initial attachment procedure in the functional architecture of FIG. 18 according to an example embodiment;

FIG. 20 is a diagram illustrating another example of the functional architecture when the functions of FIG. 8 are deployed in the network system according to an example embodiment;

FIG. 21 illustrates an initial attachment procedure in the functional architecture of FIG. 20 according to an example embodiment;

FIG. 22 is a diagram illustrating another example of the functional architecture when the functions of FIG. 8 are deployed in the network system according to an example embodiment;

FIG. 23 illustrates an initial attachment procedure in the functional architecture of FIG. 22 according to an example embodiment;

FIG. 24 is a diagram illustrating an example of the functional architecture when the functions of FIG. 12 are deployed in the network system according to an example embodiment;

FIG. 25 illustrates a control plane packet processing procedure in the functional architecture of FIG. 24 according to an example embodiment;

FIG. 26 illustrates another example of the functional architecture when the functions of FIG. 12 are deployed in the network system according to an example embodiment;

FIG. 27 illustrates another example of the functional architecture when the functions of FIG. 12 are deployed in the network system according to an example embodiment;

FIG. 28 illustrates a control plane packet processing procedure in the functional architecture of FIG. 26 or 27 according to an example embodiment;

FIG. 29 illustrates another example of the functional architecture when the functions of FIG. 12 are deployed in the network system according to an example embodiment;

FIG. 30 illustrates a control plane packet processing procedure in the functional architecture of FIG. 29 according to an example embodiment; and

FIG. 31 is a block diagram illustrating an electronic apparatus to perform communication according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The following example embodiments may be used to perform communication. Hereinafter, an operation of performing communication may include an operation of performing communication among a user equipment (UE), radio access network (RAN), and a core network (CN) using functions defined on a control plane and a user plane of a network slice. The example embodiments may be configured as various types of computing devices and/or systems, for example, a smartphone, a smart electronic device, a personal computer, a laptop computer, a tablet computer, a wearable device, etc., which constitutes the UE, or a server, etc., which constitutes the RAN/CN. The example embodiments will be described with reference to the accompanying drawings. Like reference numerals refer to like elements throughout.

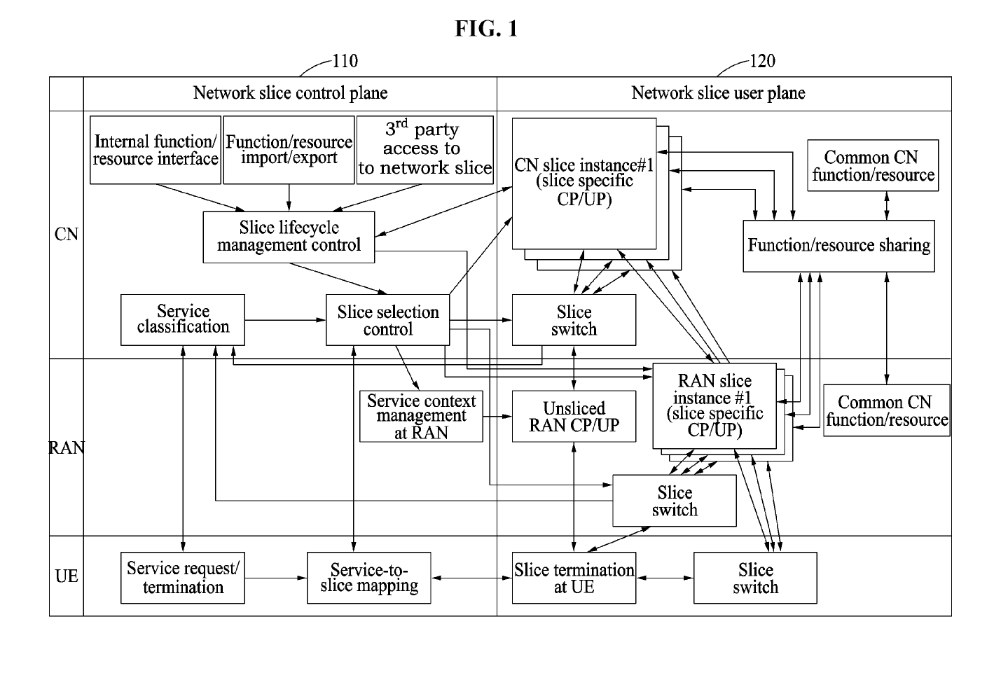

FIG. 1 is a diagram illustrating high-level functions of a network slicing according to an example embodiment.

Referring to FIG. 1, communication functions among a UE, a RAN, and a CN may be classified into a network slice control plane 110 and a network slice user plane 120.

FIG. 1 illustrates an example of a high-level functional architecture for a network slicing according to an example embodiment. This architecture may be used as a fundamental architecture for a network slice, and may be used to construct a further detailed architecture.

Here, a network slice may be configured on a virtualized resource as a coupling of virtualized network functions to provide an end-to-end network service. Network slices may have a predetermined level of separation and independence to not affect each other.

A virtual network function may indicate a network function, for example, a virtual network function, a software network function, etc., which is configured as software. A physical network function may indicate a network function, for example, a physical network function, which is configured depending on hardware. A virtualized network function may indicate a network function or a virtualized network function capable of independently separating a plurality of logical network functions by virtualizing and abstracting a physical network function.

High-level functions may be defined to include all necessary functional elements to address the requirements of network slicing. In particular, the following requirements may be considered to define the high-level functions of the architecture. Other requirements may also be supported through a further detailed work on the functions defined in the architecture.

Isolation and separation between network slice instances (NSLIs)

Resource and network function sharing between network slice instances

Enabling a UE to simultaneously obtain services from at least one specific network slice instance

Procedure(s) for selection of a specific network slice for a UE

Support network slicing roaming

Network slice that efficiently supports multiple 3^{rd} parties requiring similar network characteristics

With respect to the network slice control plane 110, network slicing may be defined as a function for providing various types of special purpose networks using underlying network+IT resources. The network slice control plane 110 may be defined as a management control function throughout a network slice lifecycle, a control function when a user uses a network slice, such as selection, a change, a termination, and the like, of a network slice, and the like.

The network slice user plane 120 may be defined as the entire functions associated with a network service provided through a network slice. In detail, the network slice user plane 120 may include functions of controlling a packet delivery among network slices and controlling a service operated on a packet.

Service request/termination refers to a function that enables a UE to exchange a control signal associated with a service request and termination between the UE and a network. The UE may directly request the network for a specific service. Alternatively, the network may determine a service based on a profile set for the UE or context to which the UE belongs. The service request/termination function may be performed based on an application basis or a UE device basis, and the like.

Service classification refers to a network-side function of classifying a service based on information sent from the UE or information managed at the network for the UE.

Slice selection control refers to a network-side function of selecting a network slice instance most appropriate for a service class and authorizing a UE to access the network slice according to an access right of the UE/user. The network slice instance may be present only in a CN, or may be present in a combined domain of the CN and the RAN. A slice selection control function may configure a new service by sending a control signal to a network slice instance via a slice switch.

Service-to-slice mapping in UE-side refers to a UE-side function that enables a UE to configure a required mapping relationship between a service and a network slice instance.

Slice switch refers to a function of forwarding a packet to an appropriate network slice instance. The slice switch enables the network slice instance to be located at a CN, a RAN, or a UE based on a domain in which the network slice instance is defined. When a packet on which forwarding information is absent arrives at the slice switch, the slice switch may request a service classification to determine a service class of the packet and may obtain forwarding information as a result of the service classification.

CN slice instance refers to a network slice instance defined over a CN. The CN slice instance may include virtualized resources of computing, storages, and CN network elements, and CN virtual network functions allocated to be used for a specific CN slice instance.

RAN slice instance refers to a network slice instance defined over a RAN. The RAN slice instance may include virtualized resources of computing, storages, and RAN network elements, and RAN virtual network function allocated to be used for a specific RAN slice instance.

Service context management at RAN refers to a RAN function of managing a service context in terms of a UE and application basis, and controlling a RAN network parameter to provide a requested service through an unsliced RAN.

Slice termination at UE refers to a UE function of terminating a slice function and characteristic, including a mapping service to a network service, generation or termination of network slice specific signal, and the like.

Common CN functions/resources refer to functions or resources that shared between a plurality of CN slice instances.

Common RAN functions/resources refer to functions or resources that are shared between a plurality of RAN slice instances.

Function/resource sharing refers to a function of sharing a common function and resource through a unified interface. The function/resource sharing may be defined as a single unified interface used for function and resource sharing, two interfaces defined for function sharing and resource sharing, respectively, or more interfaces defined based on a resource type, such as a database, a storage, computing, a network element, and the like.

Slice lifecycle management control (SLMC) refers to a function of managing and controlling a network slice and a network slice instance of a whole lifecycle of a network slice. The SLMC may include creation, duplication, modification, scale-in/out, status monitoring, and deletion of the network slice and the network slice instance.

Internal function/resource interface refers to a function of accessing resources and functions of a CN and a RAN in an administration domain of an operator. The internal function/resource interface may indicate selection and return of a function and a resource used for a network slice instance.

Function/resource import/export refers to a function of importing or exporting a function/resource with a third part or another operator.

3^{rd} party access to network slice refers to a function of opening and controlling a 3^{rd} party access to an SLMC so that a 3^{rd} party may create a network slice of the 3^{rd} party or may create a network slice instance in the created network slice.

The SLMC function may create, duplicate, modify, scale in/out, and/or delete a network slice through a whole lifecycle of the network slice using network functions and resources of computing, storages, and network elements. Resources may be provided to the network slice in a virtualized form and may ensure the isolation between network slices and the efficient sharing of physical resources. Also, the SLMC may measure and monitor a status of a network slice, may process status data, and may perform an appropriate control over the network slice.

A network slice may be embodied as a plurality of instances and a plurality of network slice instances having the same characteristic may be present. Such a network slice instance may be evolved by itself through modification and scale-in/out. The network slice controlled by the SLMC may be deployed over the whole network area including a CN and a RAN.

The SLMC may create or modify a network slice using a network function or resource provided from a 3^{rd} party or another operator. The function/resource import/export function may control an import and export process. Exchanging of a function and a resource enables resource sharing between operators, network slice roaming between domains of different operators, and creation of a 3^{rd} party's specialized network slice.

In particular, the 3^{rd} party's specialized network slice may play an important role in verticals' market, such as network industry, a smart city IT infrastructure, and the like. A network slice that satisfies service requirements may be deployed in different operator networks by exchanging a necessary function or resource between operators. Since the same network slice is deployed in another operator network, a UE that visits the other operator network may experience the same user experience.

The SLMC allows the 3^{rd} party to access the SLMC so that the 3^{rd} party may create and manage a network slice or may duplicate an existing network slice. The 3^{rd} party access to network slice function may control the 3^{rd} party's access to the SLMC for the above purpose.

Although the network slice instances may be isolated from each other using their own slice specific functions and resources, some functions or resources may need to be shared between network slice instances. For example, an authentication function needs to be shared between network slice instances based on a single sign-on service or a certification-as-a-Service. The shared functions and resources may be accessed by a plurality of network slice instances through some unified interfaces.

A unified interface may ensure the flexibility and the future proofness in the independent evolution of functions, resources, and network slices. A unified sharing interface is to be designed to allow the fair share of functions and resources between network slice instances, and at the same time, not to deteriorate the isolation between network slice instances. The unified interface may be defined as a single interface valid for all of functions and resources or as multiple interfaces specialized for each group of functions and resources.

A network slice may be selected based on a UE request or a network decision. A UE may request a network for a service based on a session basis, an application basis, or a UE connection basis. In response to receiving the request from the UE, the network may classify the service according to a service classification policy predesigned by an operator. Also, the network may classify the service into a user/UE profile and a current context in which a user/UE resides.

A result of service classification may be transferred to a slice selection function. The slice selection function may determine a network slice instance appropriate for a requested service class based on an available network slice instance list and a slice status report created at the SLMC. Also, the slice selection function may verify an access right of a UE to a corresponding network slice instance and may complete the decision accordingly.

After selecting a network slice instance, a UE may receive information about the selected network slice instance from the slice selection function, may configure a parameter, and may process a related network slice. Also, the slice switch may configure a forwarding table to send a packet to the selected network slice instance. The slice switch may locate either of a CN, a RAN, or a UE based on a deployment area of a network slice. Three slice switches of FIG. 1 may represent such a location variation.

Slice related functions at UE, such as service-to-slice mapping, slice termination, and slice switch, may be all used to support for the UE to simultaneously access a plurality of network slices for a single application or multiple applications.

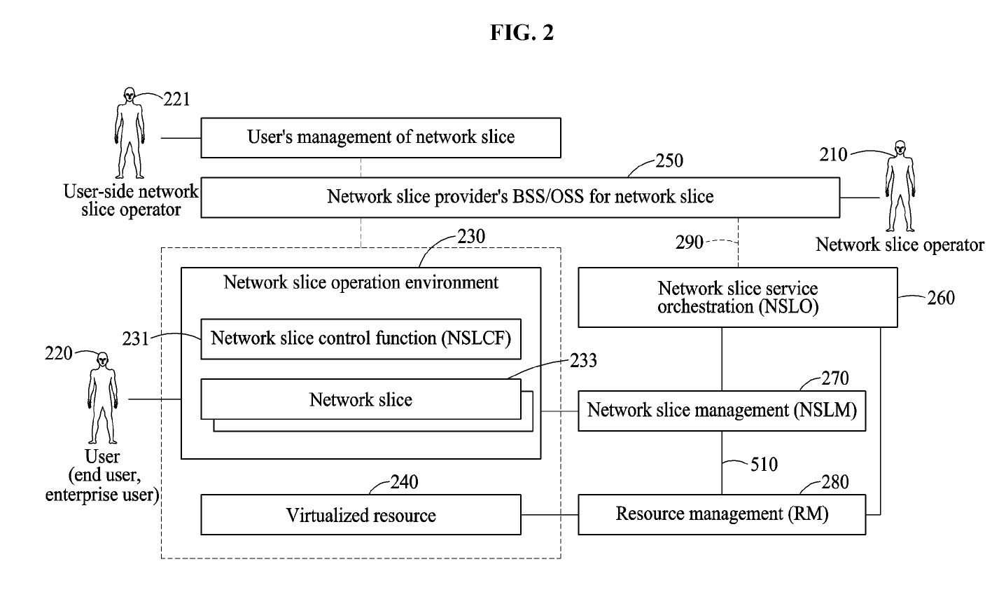

FIG. 2 is a diagram illustrating an architecture of a network slice system according to an example embodiment.

A network slice may be a coupling of at least one network function virtualized to provide an end-to-end network service. FIG. 2 illustrates the architecture of the network slice system proposed herein. A network slice 233 may be configured on a virtualized resource 240 in which computing, a storage, a network, etc., are virtualized. A network slice control function (NSLCF) 231 may be used to control an operation of the network slice 233. A network slice operation environment 230 may include the network slice control function 231 and a plurality of network slices 233. Here, the network slice control function 231 may include a function of operating and managing an operation status and fault, etc., of a network slice unit and a function of controlling a network slice attachment.

A network slice management (NSLM) 270 may indicate a function of directly controlling the network slice 233 and virtualized network functions that constitute the network slice 233 to manage a lifecycle, such as creation, modification, termination, etc., of the network slice 233.

A resource management (RM) 280 may indicate a function of directly controlling a resource to manage a lifecycle, such as creation, modification, termination, etc., of the virtualized resource 240.

A network slice service orchestration (NSLO) 260 may perform an orchestration and execution environment control of a network service provided from the network slice 233. Here, the execution environment control may indicate configuring the virtualized resource 240 for executing the network service. For example, in response to a corresponding virtualized resource request from the NSLO 260 to the RM 280, the RM 280 may configure a resource capable of executing the network slice 233 through a control management of a relevant resource and may provide the configured resource. The NSLO 260 may send network slice configuration information according to the network service to the NSLM 270 so that the network slice 233 that is combination of virtualized network functions may be configured.

In response to an occurrence of change, termination, etc., of the network slice 233, such as expansion (scale-out), reduction (scale-in), etc, of the network slice 233, the NSLM 270 in addition to the NSLO 260 may directly request the RM 280 for change, control, and management of the corresponding resource.

The aforementioned NSLO 260, NSLM 270, and RM 280 may correspond to a network function virtualization orchestrator (NFVO), a VNF manager (VNFM), and a virtualized infrastructure manager (VIM) of an ETSI network function virtualization management & orchestration (NFV-MANO), respectively. Herein, the network slice architecture is defined to meet an ETSI NFV architecture and a relevant operation is proposed.

A network slice operator 210 may operate and manage the network slice 233 through a network slice provider's operations support system/business support system (BSS/OSS) 250 for the network slice 233, and may provide a relevant service to a user 220 and a user-side network slice operator 221. The BSS/OSS 250 may define the network slice 233 at an upper level desired by the user 220, and may request the NSLO 260 for realization of the defined network slice 233. Also, the BSS/OSS 250 may measure and analyze an operation and fault status of a network slice operation environment 230, the virtualized resource 240, and the like, and if necessary, may request the NSLO 260, the NSLM 270, the RM 280, and the like, for control and management of a relevant function through an attachment point 290.

The user 220 refers to a UE that attaches to the network slice 233 to utilize a network service, and may include, for example, an end user and an enterprise user. Here, when a network service desired by the user 220 is not provided, or if the desired network service is provided, however, a desired service is not provided through a currently executing network slice due to a lack of resources in terms of space or performance, the user 220 may request the user-side network slice operator 221 for a related action. In response thereto, the user-side network slice operator 221 may request creation of a new network slice or a change of an executing network slice through a network slice control portable provided from a BSS of the BSS/OSS 250 of the network slice operator 210.

The user 220 may receive a dynamic slice through a network slice in terms of the following three aspects. A first dynamic service may be performed through creating a new network slice or modifying an exisiting network slice. The dynamic service request may be performed through the aforementioned network slice management portal, and may be performed by configuring a completely new network slice or selecting a network slice from a network slice catalog. In this manner, the creation or modification of a global-scaled network slice may be performed in the order of a few minutes.

A second dynamic service may be a selection of a network slice. In response to the user 220's initial attachment to a network in a state in which a network slice specified for each service is in execution, a network slice providing a service desired by the user 220 may be selected and may be provided to the user 220. When the user 220 desires a new service after the initial attachment, another network slice may be additionally provided. The user 220 may simultaneously use a plurality of network slices.

A third dynamic service may be performed within a selected network slice. Even in the case of the same type of services, a service may be optimized based on a user's needs and environment. A dynamic service may be provided based on a smallest unit, for example, per packet or a service flow, and the like. This level of dynamic service may respond to a service request most quickly. For example, a reaction time may be within 1 millisecond.

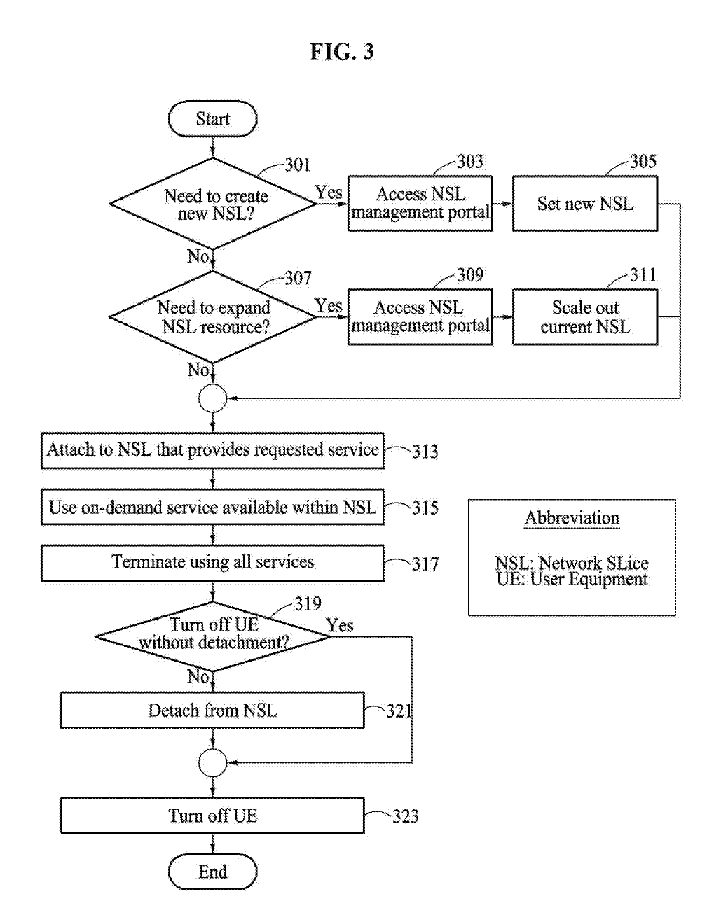

FIG. 3 is a flowchart illustrating a communication method of a service using a network slice according to an example embodiment.

FIG. 3 illustrates a flowchart illustrating a use operation of a network slice on a user side. Hereinafter, an operation procedure of providing a service through a network slice will be described with reference to FIG. 3.

Operation 301 may be performed in response to a UE starting to use a network.

In operation 301, the UE may determine whether there is a need to create a new network slice. When there is a need to create the new network slice, the UE may access a network slice management portal in operation 303, and may compose a new network slice in operation 305.

Conversely, when there is no need to create a new network slice, the UE may determine whether there is a need to expand an existing network slice resource in operation 307. When there is a need to expand the network slice resource, the UE may access the network slice management portal in operation 309, and may scale out or scale in a current network slice in operation 311.

In operation 313, the UE may attach to a network slice that provides a requested service. In operation 315, the UE may use an on-demand features of the service available within the network slice. In operation 317, the UE may terminate using all the services provided within the network slice.

In operation 319, the UE may determine whether to turn off the UE without a detachment procedure. When turning off the UE after detachment, the UE may detach from the network slice in operation 321.

In operation 323, the UE may be turned off.

It is assumed that a network function is separated into a control plane function and a user plane function. The control plane function may include functions for controlling a transfer/processing procedure associated with user packets that are transferred to and processed at a user plane. Herein, the control plane function and the user plane function may be completely separate from each other. That is, with the assumption that correlation is absent between network functional architectures of the control plane and the user plane, the control plane function and the user plane function may be designed to be separate from each other. When a plurality of polices is present for configurations and procedures of the control plane and the user plane functions being separate, a policy of each plane may be independently selected and applied.

Hereinafter, lines that connect functions illustrated in the drawings may be logical connection lines unless particularly described. If there is a physical meaning, it will be clearly described. Also, an example embodiment that physically configures a logical connection line is proposed herein.

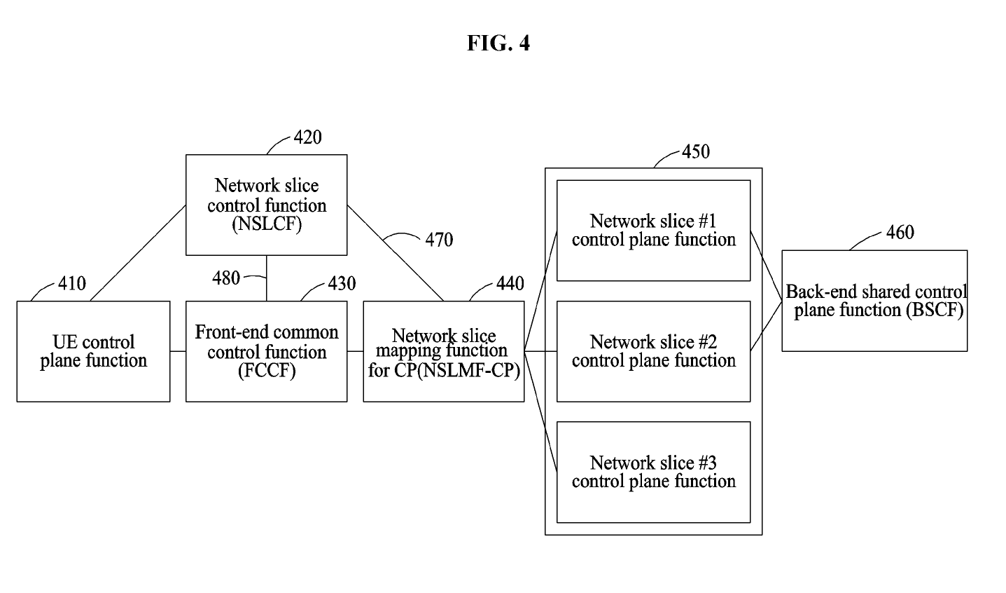

FIG. 4 is a diagram illustrating a functional architecture on a control plane of a network slice according to an example embodiment.

FIG. 4 illustrates control-plane network functions used when a user attaches to a network slice 450 currently in execution. When a single user is to simultaneously use the plurality of network slices 450, there may be some control-plane network functions being shared between a part or all of the network slices 450.

Some of the control-plane network functions being shared may need to be executed prior to executing the network function whitin a network slice 450 and to be shared among all of the network slices 450. This function is referred to as a front-end common control function (FCCF) 430.

An example of the FCCF 430 may include a mobility management function among mobile communication network functions. The mobility management function is associated with a location of a mobile terminal (i.e. user equipment: UE) and thus, may be executed as a common function rather than being executed whithin each network slice 450 so that all of the network slice 450 may share the result.

The sharing network control functions may include a function being shared between only a part of the network slices 450. This function is referred to as a back-end shared control function (BSCF) 460. For example, in FIG. 4, there may be a function shared only between a network slice #1 control plane function and a network slice #2 control plane function.

FIG. 4 illustrates functions associated with a network slice attachment procedure when the FCCF 430 and the BSCF 460 are present according to an example embodiment. An NSLCF 420 may perform a function, such as a network slice selection, a user or a UE authentication, and the like. Also, the NSLCF 420 may create a temporary identifier (ID) of a UE as a result of the user authentication and may transfer the created temporary ID to a related network function. The NSLCF 420 may include fault, configuration, accounting, performance, security (FCAPS) functions of a network slice unit, that is, element management (EM) functions of a network slice unit.

A network slice mapping function for control plane message (NSLMF-CP) 440 may perform identifying a network slice instance to process CP messages from a forwarding table and transferring a CP message to the identified network slice instance.

The network slice instance may be replaced with a new network slice instance through a network slice operator's management for network slice operator's own sake. A UE (or user) needs to attach to a network slice instance indirectly in order to switch the attachement to a new network slice instance without the UE's recognizing it. That is, the UE may be informed of only a network slice ID and a relationship between the network slice ID and an instance of the network slice may be managed through the forwarding table. In this manner, a UE may attach to a changed network slice instance with the network slice ID by looking it up in the forwarding table which provides the mapping relationship between a network slice ID and a corresponding network slice instance. To perform the above function, the NSLMF-CP 440 may indentify the network slice instance from the forwarding table with the temporary ID of the UE and the network slice ID provided by the UE. Here, the UE may particularity be meant a UE control plane function 410.

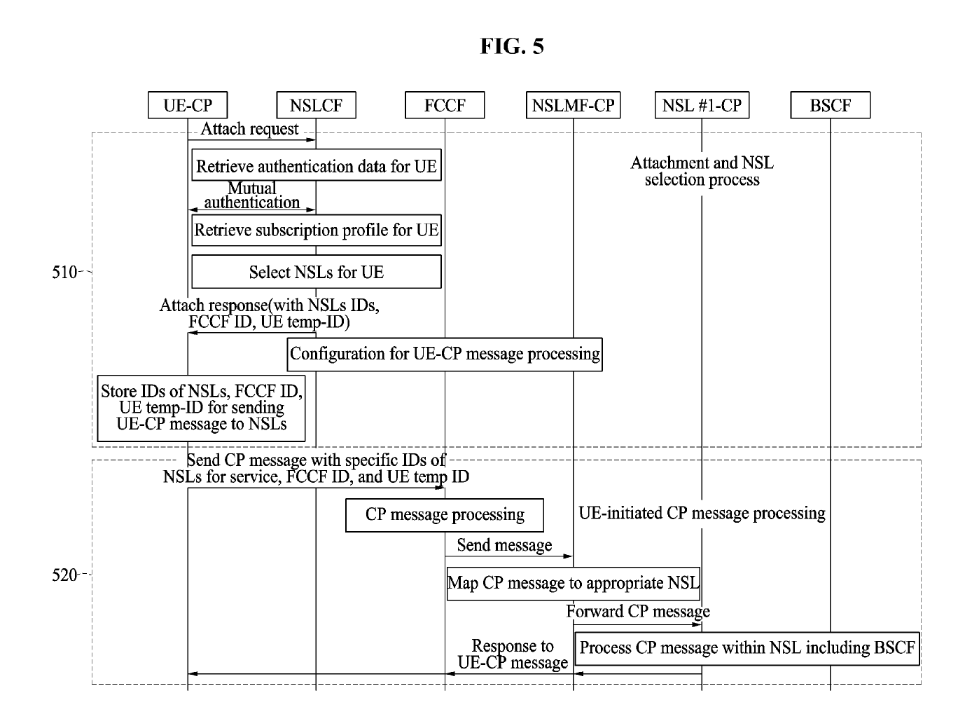

FIG. 5 illustrates an initial attachment procedure of a UE to a network slice instance and related control message processing procedure according to an example embodiment.

FIG. 5 illustrates a procedure in which a UE performs an initial attachment to a network slice using network control functions defined in FIG. 4.

In an attachment and network slice selection process 510, an initial attach request may be sent from a control plane function of a UE (UE-CP) to an NSLCF of a network. The attach request may include a type of a service desired by a UE, a capability of the UE, and the like.

Here, the service type may include a type of the desired service (e.g., enhanced mobile broadband (eMBB), massive machine type communication (mMTC), ultra-reliable low latency communication (uRLLC), etc.), an application service identifier (e.g., www.google.com. etc.), a data network name desired to connect (e.g, the Internet, IP multimedia subsystem (IMS), etc.), and the like. In the case of a reattachment, details of network slices allowed for attachment in a previous attachment may be included in the attach request.

In response to the attach request, the NSLCF may retrieve authentication information about the UE from a subscriber information storage, may perform a mutual authentication with the UE through a encrypted secure environment, and may verify whether the UE-CP is a subscriber allowed for network slice attachment.

Once the mutual authentication is successfully completed, the NSLCF may retrieve a subscription profile from the subscriber information storage. The retrieved subscription profile may include details of network slices allowed for the subscriber.

A network slice to be provided to a corresponding subscriber by default may be defined in the subscription profile. A default network slice indicates a network slice that basically allows attachment of the UE although information about a service requested by the UE is not provided. For example, when the UE is a sensor terminal, a network slice that provides a sensor network service may be defined as the default network slice. When the UE is a TV, a network slice that provides a multimedia service may be defined as the default network slice. When the UE is a smartphone, a network slice that provides a mobile communication network service may be defined as the default network slice.

The NSLCF may select a network slice corresponding to a UE-CP request message based on the subscription profile and the attach request, for example, a service type, a terminal type, and previously allowed network slice information that are sent from a UE. That is, the NSLCF may determine a set of network slices corresponding to the request message from the UE-CP. Here, an FCCF capable of providing a most appropriate service to the user may be determined based on a current status (e.g., a service and a spatial circumstance) of the UE, a local status of a network, and a relevant network operator's policy.

The NSLCF may send the set of determined network slices, an FCCF ID, and a temporary ID the network newly allocates to the UE, to the UE-CP as an attach response to the attach request. The NSLCF may send a temporary ID of a UE and selected network slice information to the determined FCCF and an NSLMF-CP connected to the FCCF, so that the UE ID and the set of network slice IDs may be set to the FCCF and the NSLMF-CP. Here, the NSLCF may use an interface 480 instead of using an interface 470 when sending corresponding information to the NSLMF-CP, and may send the corresponding information through the FCCF.

The UE-CP may store the network slice details and the FCCF ID received through the attach response and the temporary ID of the UE-CP allocated by the network. Through this, if necessary, the UE-CP may send a part of or all of these stored information when it sends a control message to the network.

The UE-CP of the user may complete an initial attachment procedure of the network slice through the aforementioned processes. The UE-CP may send a control message associated with a service to the network slice when it request or control the network service. Here, the control message may include a request for the protocol data unit (PDU) session establishment, a update of UE location, and the like, associated with the service. These procedures will be described with reference to an UE-initiation CP message processing 520.

The UE-CP may send a CP message to the FCCF. Here, the CP message may include the ID of the FCCF (FCCF ID), the temporary ID of the UE (UE temp ID), and IDs of network slices to which the CP message is to be transferred (IDs of NSLs). The CP message may be transferred to and processed by the FCCF and the NSLMF-CP.

The FCCF may process a function corresponding to a common control function among functions required by the CP message. Also, if necessary, the FCCF may transfer the CP message to the NSLMF-CP so that the CP message may be transferred to a network slice based on a type of the CP message.

The NSLMF-CP may identify a network slice instance corresponding to an ID of a network slice from a forwarding table managed by the NSLMF-CP, based on the temporary ID of the UE and the IDs of the network slices. The NSLMF-CP may forward the CP message to the identified network slice instance. The transferred CP message may be processed at a BSCF and a corresponding network slice instance. The processing result may be transferred to the UE-CP as a response to the CP message through the NSLMF-CP and the FCCF, consecutively.

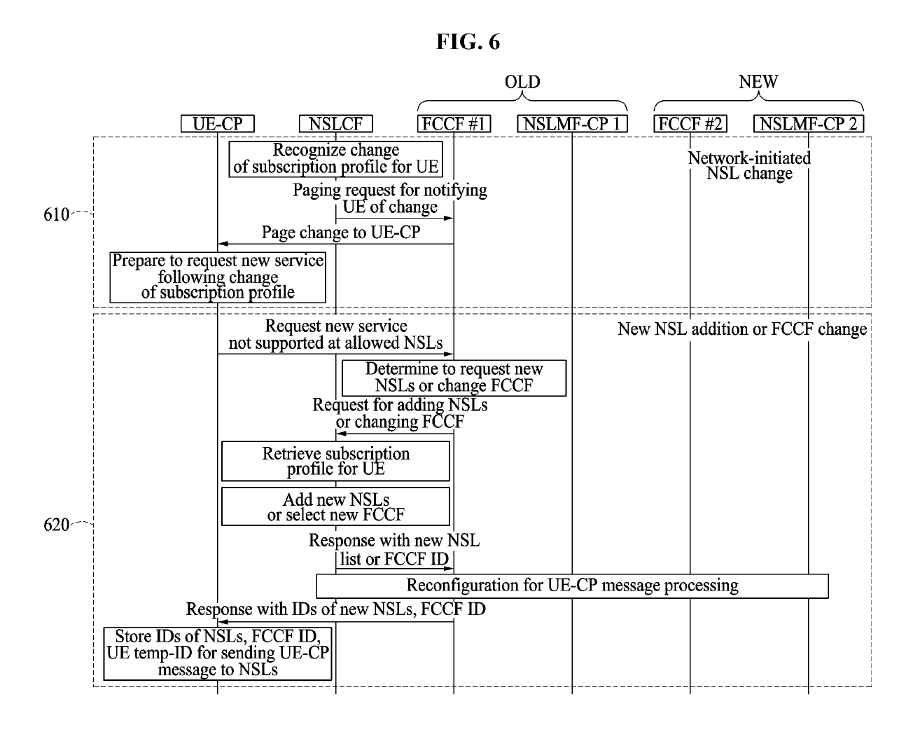

FIG. 6 illustrates a procedure of adding a network slice according to an example embodiment.

In response to a change of a subscription profile of a user, a new service request of the user, and the like, a new network slice in addition to a currently allowed network slice may be additionally allocated to a UE. During an addition procedure, an FCCF allocated to the UE may be changed from existing allocated FCCF #1 to new FCCF #2.

FIG. 6 illustrates a network slice addition procedure initiated by two reasons. For example, the network slice addition procedure may include a network-initiated NSL change 610 and a new network slice addition. During the addition procedure, an FCC change and a change of an NSLMF-CP according thereto may be performed.

In detail, if a new network slice is added in response to a change of the subscription profile of the user, that is, in the case of the network-initiated network slice change 610, an NSLCF may recognize the change through an internal network function. That is, the NSLCF may recognize the change of the subscription profile for the UE. The NSLF may transfer a paging request for notifying the UE of the change to the FCCF #1. The FCCF #1 may page the change to the UE-CP. That is, the FCCF #1 may notify the UE-CP about the change of the subscription profile. The UE-CP notified about the change of the subscription profile may prepare to request a new service following the change of the subscription profile.

In the case of a new network slice addition or FCCF change 620, the UE-CP may send a request for a new service not supported at allowed network slices to the FCCF #1. The FCCF #1 may recognize the new service request and may transfer the new service request to the NSLCF. The NSLCF may retrieve the subscription profile for the UE and may select new network slices or a new FCCF. The NSLCF may send a response including a new network slice list or an FCCF ID to the FCCF #1. The NSLCF may update the FCCF and the NSLNF-CP with the corresponding contents to apply the modified contents to the FCCF and the NSLMF-CP. The FCCF (FCCF #1) and the NSLMF-CP (NSLMF-CP1) may be changed based on the new network slices. In this case, corresponding contents may be deleted from the FCCF (FCCF#1) and the NSLMF-CP (NSLMF-CP1) before change, and the changed contents may be set to the FCCF(FCCF#2) and the NSLMF-CP(NSLMF-CP2) after the change. The FCCF#1 may send a response including IDs of new network slices and the FCCF ID to the UE-CP. The UE-CP may store the IDs of the new network slices, the FCCF ID, and the temporary ID of the UE to send a UE-CP to the network slices.

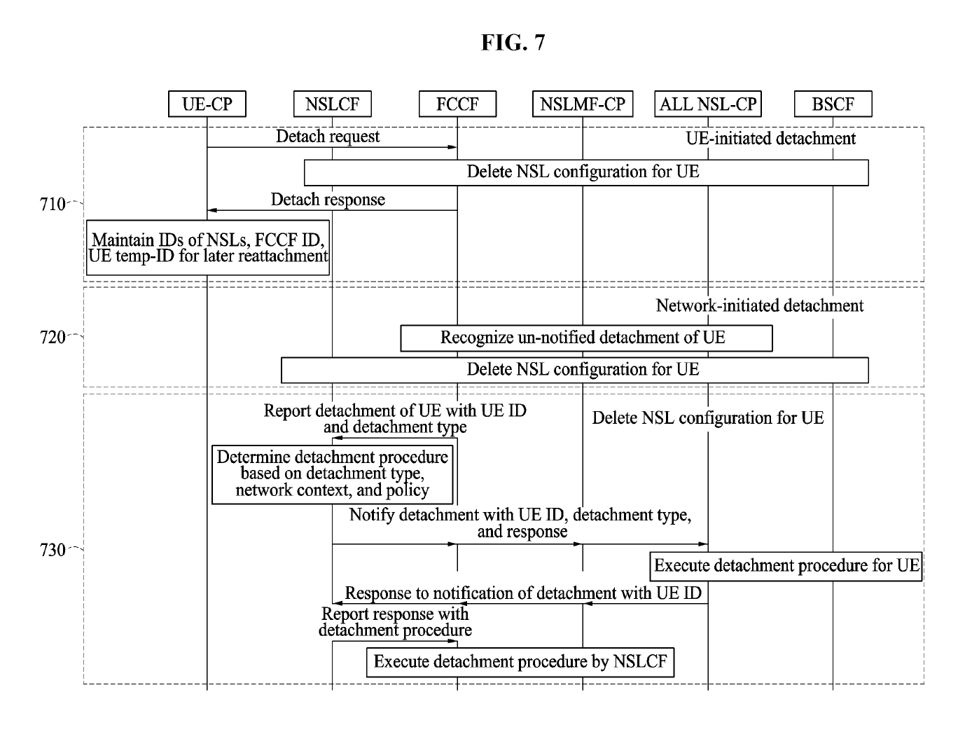

FIG. 7 illustrates a detachment procedure of a network slice according to an example embodiment.

A network slice termination may include a termination by a request from a UE, and an unrequested termination, for example, an un-notified turn-off of the UE, and the like, may be present. FIG. 7 illustrates a detachment procedure in the termination of the network slice as above.

In the case of a UE-initiated detachment 710, a UE-CP may send a detach request to an FCCF. A network slice configuration for the UE may be deleted. The FCCF may send a detach response to the UE-CP. The UE-CP may store IDs of network slices, the ID of the FCCF, and a temporary ID of the UE for later reattachment.

In the case of a network-initiated detachment 720, an un-notified detachment of the UE may be recognized by the network. The network slice configuration for the UE may be deleted.

In response to execution of one of the UE-initiated detachment 710 and the network-initiated detachment 720, a process 730 of deleting the network slice configuration for the UE may be performed. In detail, the FCCF may report to the NSLCF about the detachment of the UE with the ID of the UE and a detachment type. The NSLCF may determine the detachment procedure based on the detachment type, a network context, and a policy. The NSLCF may notify the FCCF, the NSLMF-CP, and all NSL-CP about the detachment with the ID of the UE, the detachment type, and the detachment procedure. All NSL-CP and the BSCF may execute the detachment procedure for the UE. A response to the detachment notification may be transferred from all NSL-CP to the NSLCF through the NSLMF-CP and the FCCF with the ID of the UE. The NSLCF may report to the FCCF about the response with the detachment procedure. The NSLCF may execute the detachment procedure. Here, before final detachment, the UE may store IDs of network slices allowed for use, the ID of the FCCF, the temporary ID allocated to the UE, and the like, to reuse the same during a later reattachment process.

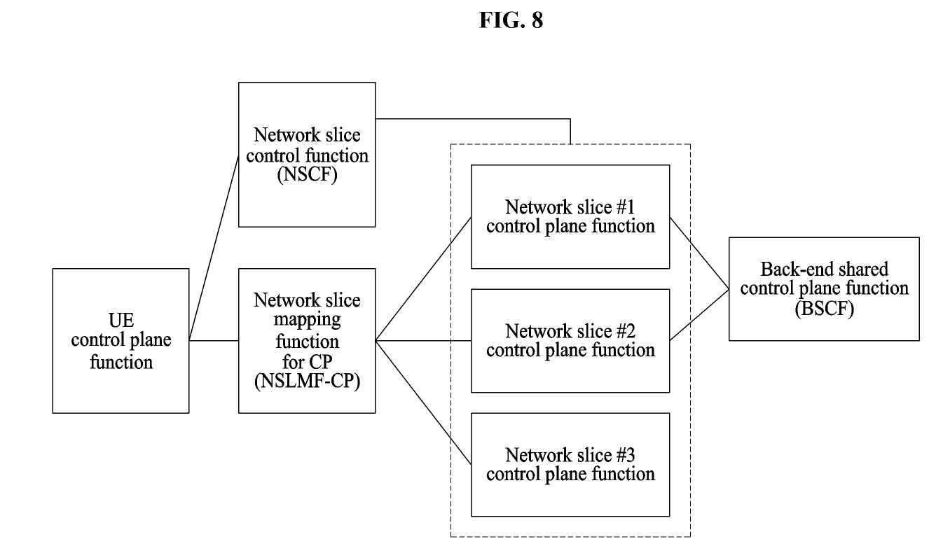

FIG. 8 illustrates a functional architecture on a control plane of a network slice according to another example embodiment.

The descriptions made above with reference to FIGS. 4 through 7 relate to a case in which an FCCF is required. FIG. 8 illustrates a case in which the FCCF is absent, that is, a case in which a function commonly used by all network slices before using any control function whithin network slices is absent. For example, a UE for the latter case may be a wired terminal or a fixed wireless terminal.

That is, FIG. 8 illustrates a case in which the FCCF 430 of FIG. 4 is absent. The functions of FIG. 8 are the same as those of FIG. 4 and thus, a further description is omitted. Here, an FCCF ID stored by the UE and sent with a CP message may be replaced with an NSLMF-CP ID.

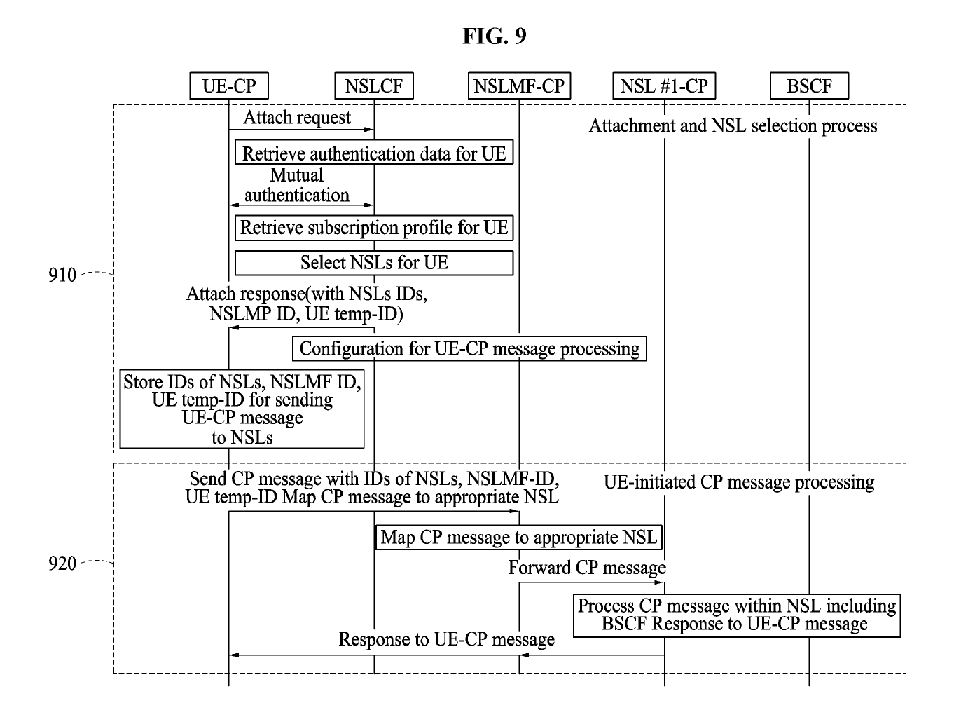

FIG. 9 illustrates an initial attachment procedure and a control message processing procedure of a network slice according to another example embodiment.

FIG. 9 illustrates an initial attachment procedure and a CP message processing procedure after attachment according to an example embodiment. The overall operation excluding an operation of a FCCF is the same as shown in FIG. 5. Here, an ID of an NSLMF-CP may be transferred to a UE-CP when the NSLMF-CP is configured in a CN or an AN, and may not be transferred to the UE-CP when the NSLMF-CP is configured in the UE.

That is, an attachment to and selection of a network slice process 910 and a UE-initiated control plane (CP) message processing 920 of FIG. 9 may be the same as those of FIG. 5 except that the FCCF is absent. Thus, a further detailed description is omitted.

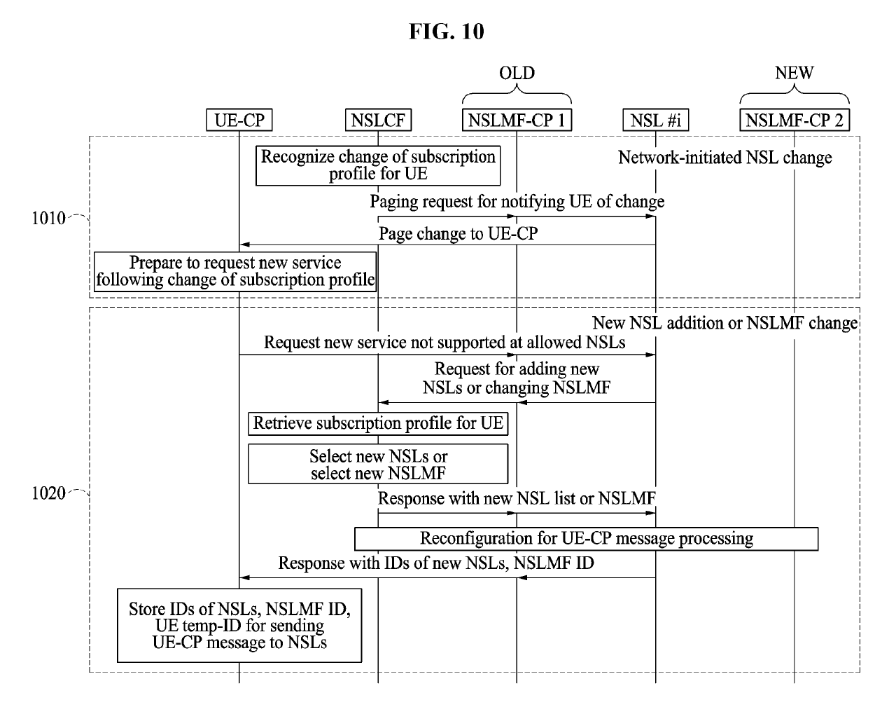

FIG. 10 illustrates a procedure of adding a network slice according to another example embodiment.

FIG. 10 illustrates a network-initiated network slice change 1010 and a new network slice addition or NSLMF change 1020.

Addition of a network slice may be performed by a network through change of a subscription profile, or may be performed in response to a user request. An NSLCF may notify the UE about change of the subscription profile through one of network slices being used by the user, so that a network slice change request may be performed through a service request message sent from the UE.

In detail, in the case of the network-initiated network slice change 1010, the NSLCF may recognize the change of the subscription profile for the UE. The NSLCF may send a paging request for notifying the UE about the change to NSL #i through NSLMF-CP1. The NSL #i may page the change to the UE-CP. The UE-CP may prepare to request a new service following the subscription change.

In response to a service change request (e.g., a CP message) from the UE sent to one of the network slices in use, the corresponding network slice may send the corresponding CP message to the NSLCF so that the network slice may be changed to meet the service change request. The network slice change or addition is completed by applying an ID of the new network slice (new network slice ID) to the UE and the NSLMF. Here, the NSLMF-CP may be changed based on the new or changed network slice insatnce. In this case, the corresponding contents may be deleted from the NSLMF-CP (NSLMF-CP1) before change and the changed contents may be set to the NSLMF-CP (NSLMF-CP2) after the change.

In detail, in the case of the new network slice addition or NSLMF change 1020, the UE-CP may send a new service request not supported at allowed network slices to

NSL #i through the NSLMF-CP1. The NSL #i may send a network slice addition or NSLMF change request to the NSLCF through the NSLMF-CP1. The NSLCF may retrieve a subscription profile for the UE and may add new network slices or select a new NSLMF. The NSLCF may respond with a new network slice list or NSLMF. The response may be sent to the NSL #i through the NSLMF-CP1. A reconfiguration for UE-CP message processing may be performed. The NSL #i may send IDs of the new network slices and an NSLMF ID to the UE-CP as a response. This response may be transferred to the UE-CP through the NSLMF-CP1. The UE-CP may store the IDs of the new network slices, the NSLMF ID, and a Temporary ID of the UE to send a CP message to the network slices.

In FIG. 10, the NSLMF-CP1 may represent the NSLMF in use and the NSLMF-CP2 may represent the newly allocated NSLMF in response to the change.

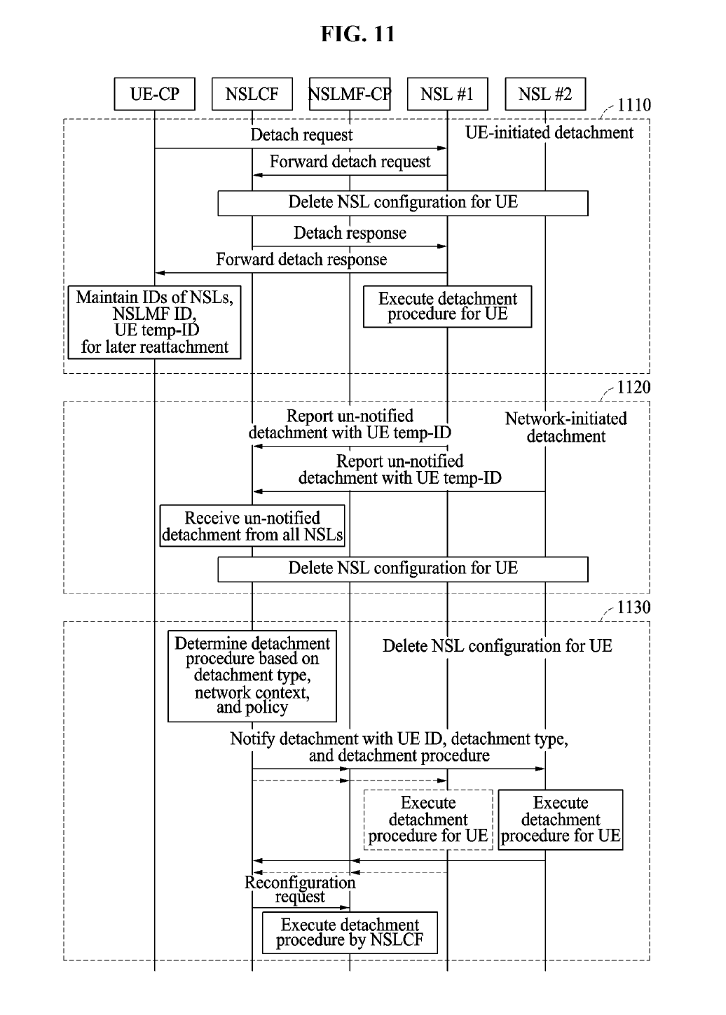

FIG. 11 illustrates a detachment procedure of a network slice according to another example embodiment.

A network slice detachment procedure may include a detachment by a detach request from a UE and a detachment not requested from the UE but recognized at each network slice in use by the UE. Here, the detachment refers to that the UE terminates an attachment to a network and thus, may indicate terminating use of all of the network slices.

Initially, the detachment by the detach request from the UE may indicate a UE-initiated detachment 1110. In detail, a UE-CP may send a detach request to NSL #1. The NSL #1 may forward the detach request to an NSLCF. A network slice configuration for the UE may be deleted. The NSLCF may send a detach response to the NSL #1. The NSL #1 may forward the detach response to the UE-CP. The UE-CP may store IDs of network slices, an NSLMF ID, and a temporary ID of the UE for later reattachment. Also, the NSL #1 may execute the detachment procedure for the UE.

That is, in the case of the detach request from the UE, once the detach request is sent to one of network slices in use, a network slice receiving a corresponding message, that is, the detach request may forward the corresponding message to the NSLCF and the detachment procedure may be executed at the NSLCF.

Also, the detachment by the detachment recognized at each of the network slices in use may indicate a network-initiated detachment 1120. In detail, the NSL #1 may report to the NSLCF about an un-notified detachment with a temporary ID of the UE. Also, NSL #2 may report to the NSLCF about the un-notified detachment with the temporary ID of the UE. That is, the NSLCF may receive notifications about the un-notified detachment from all of the network slices. In this case, the NSLCF may delete a network slice configuration for the UE.

That is, in the case of the detachment recognized at each of the network slices in use (e.g., in the case of detachment by turn-off of the UE, etc.,), the detachment of the UE may be recognized by all of the network slices in use and corresponding information may be sent to the NSLCF. The NSLCF may verify that attachment of the UE is terminated at all of the network slices allowed for the UE and may execute a network slice detachment procedure.

In response to execution of the UE-initiated detachment 1110 and the network-initiated detachment 1120, a process 1130 of deleting the network slice configuration for the UE may be performed. In detail, the NSLCF may determine the detachment procedure based on a detachment type, a network context, and a policy. The NSLCF may notify NSL #1 and NSL #2 about the detachment with the UE ID, the detachment type, and the detachment procedure through the NSLMF-CP. The NSL #1 and the NSL #2 notified of the detachment may execute the detachment procedure for the UE. The NSL #1 and the NSL #2 may send a response to the notification of the detachment to the NSLCF through the NSLMF-CP with the UE ID. The NSLCF may send deletion information corresponding to the detachment to the NSLMF-CP. The NSLMF-CP may delete information associated with the detachment and may execute the detachment procedure by the NSLCF.

Here, in the case of the UE-initiated detachment 1110, a network slice, that is, NSL #1, having received the detach request from the UE may send a network slice use detach response to the UE and may delete relevant network settings from a network slice of the NSL #1. Accordingly, a portion indicated with dotted lines in the process 1030 of deleting the network slice configuration for the UE may be omitted when the UE-initiated detachment 1110 is initiated.

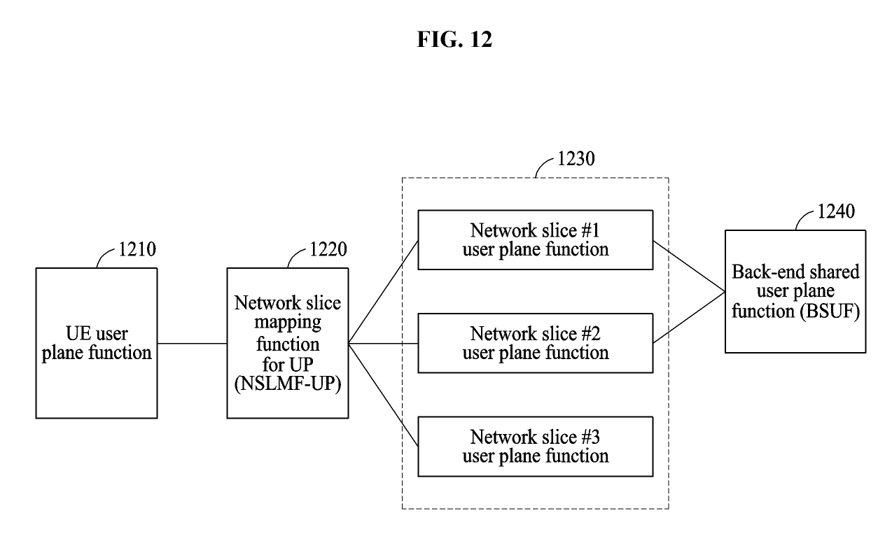

FIG. 12 is a diagram illustrating a functional architecture on a user plane of a network slice according to an example embodiment.

FIG. 12 illustrates a user plane function associated with attachment of a network slice.

A network slice mapping function for user plane (NSLMF-UP) 1220 performs the same functionality as the NSLMF-CP 440 of FIG. 4 and differs in that a user plane packet is processed. A primary function of the NSLMF-UP 1220 may be a function of indentifying a network slice instance a user desires to attach to based on an ID of the network slice and a temporary ID of the UE provided from a user. The description related to the NSLMF-CP 440 may be applicable to this function and thus, a further description is omitted.

A back-end shared user plane function (BSUF) 1240 may indicate a network function of the user plane shared among a part of or all of the network slices allocated to the UE. For example, the BSUF 1240 may include a database that may be used during processing a function at the user plane. Each of network slices 1230 for user plane functions may be combined with each network slice 450 of FIG. 4 for control plane functions and may configure a single network slice which includes both the user and control plane functions.

A UE user plane function (UE-UP) 1210 may indicate a user plane function of the UE. The UE may consist of UE-UP 1210 and the UE-CP 410 of FIG. 4.

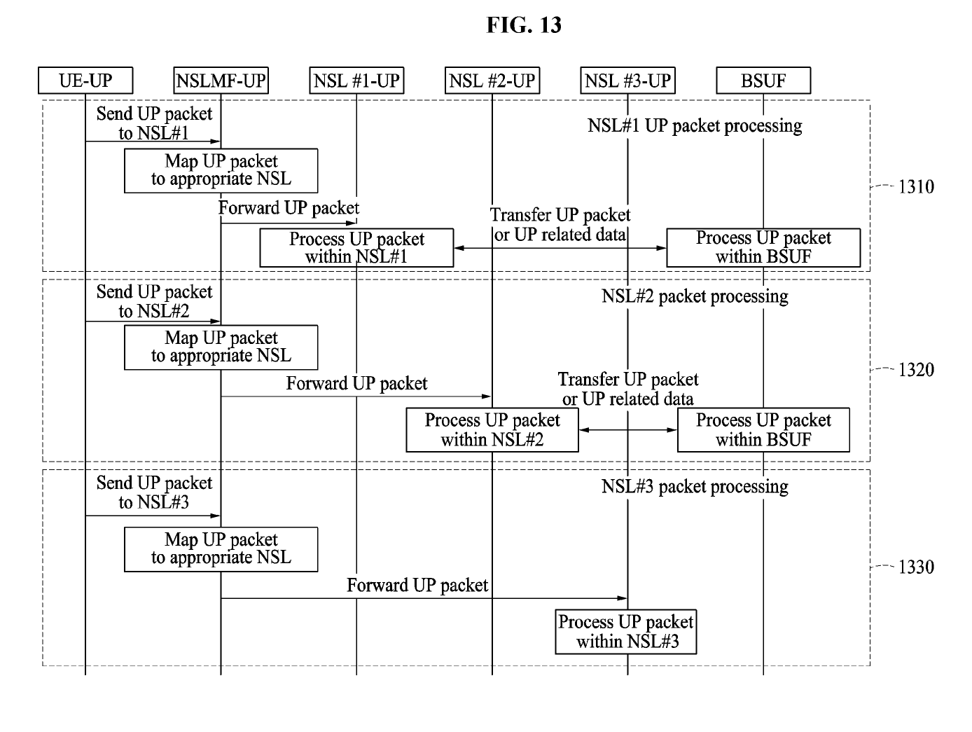

FIG. 13 illustrates a functional processing procedure on a user plane of a network slice according to an example embodiment.

FIG. 13 illustrates a procedure of receiving a service through attachment to a network slice on a user plane.

Data/packet of the user plane may be transferred to a corresponding network slice through an NSLMF-UP. A service may be completed by processing the data/packet at the corresponding network slice and BSUF. FIG. 13 illustrates a case in which a network slice 1 (NSL #1-UP) and a network slice 2 (NSL #2-UP) use the BSUF.

In detail, in the case of an NSL #1 UP packet processing 1310, a UE-CP may send a UP packet to the NSLMP-UP. The NSLMP-UP may select an appropriate network slice, for example, NSL #1, based on IDs of network slices and a UE ID present in the UP packet. The NSLMP-UP may forward the UP packet to the selected NSL #1. The UP packet may be processed at the NSL #1 and the BSUF.

In the case of an NSL #2 UP packet processing 1320 and an NSL #3 UP packet processing 1330, a corresponding UP packet may be processed, which is similar to the NSL #1 UP packet processing 1310. In the case of the NSL #3 UP packet processing 1330, the NSL #3 does not use the BSUF and thus, the UP packet may be processed only at the NSL #3.

The network slice attachment, change, and detachment procedures according to example embodiments are described in terms of functions. Hereinafter, a method of deploying the functions to an actual network configured as a (radio) access network (R)AN and/or a core network (CN) will be described. Additional functions, such as an NSLCF selection (NSLCFS), a forwarding function (FF), and the like, for operating the aforementioned functions may be newly defined on the (R)AN area.

All the aforementioned network slice attachment, change, and detachment procedures may be applicable to the function deployment. Accordingly, additional contents caused by the function deployment and procedures associated with the NSLCFS and the FF will only be described.

Various function deployments may be present according to the deployment of the NSLMF and a network slice realization in the RAN. The function deployment will be described in terms of each of the control plane and the user plane. Actual function deployment may be performed through arbitrary combination.

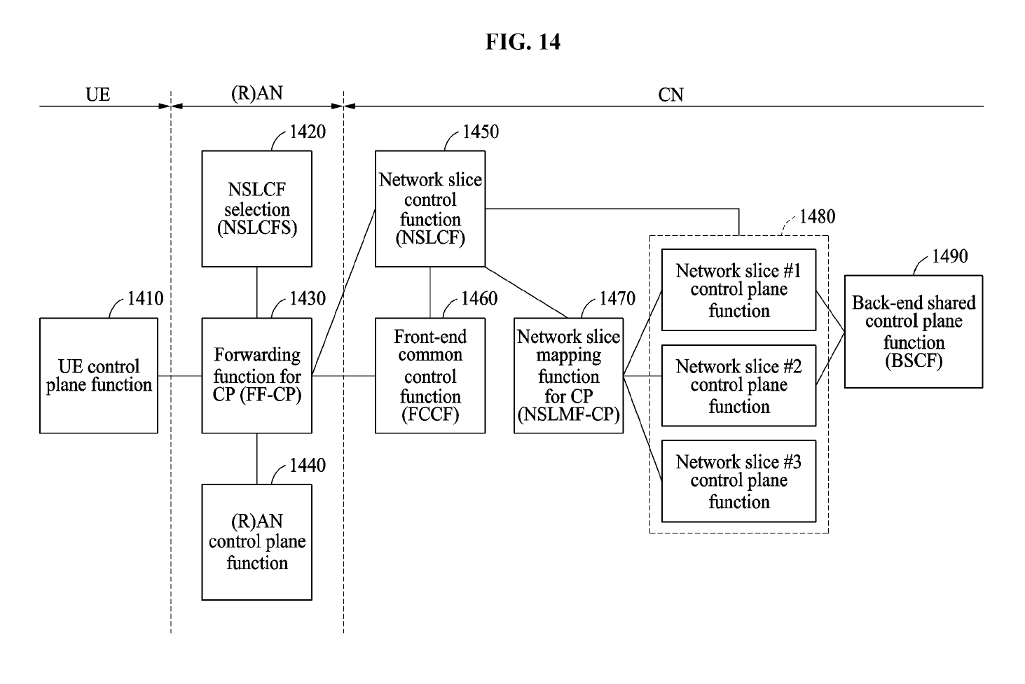

FIG. 14 is a diagram illustrating an example of a functional architecture when the functions of FIG. 4 are deployed in a network system according to an example embodiment.

An NSLCFS 1420 may indicate a function of selecting an NSLCF 1450 optimal for a UE to transfer an attach request transferred to a RAN to the NSLCF 1450 belong to a CN. Also, an FF 1430 may be located in the RAN and may indicate a function of routing a CP message of the UE to the NSLCF 1450 or an FCCF 1460 of the CN.

FIG. 14 illustrates a function deployment in a case in which control plane functions of FIG. 4 are deployed in an actual network.

The NSLCF 1450, the FCCF 1460, an NSLMF-CP1470, a network slice 1480, and a BSCF 1490 may be deployed in the CN. The CP message of the UE may be transferred to the CN through the RAN. Location information of each function is absent during an initial attachment and thus, a location of each function may be analyzed and determined at the RAN. That is, the NSLCF 1450 most appropriate for a service request from the UE is to be determined, and may be determined based on information provided from the UE. As described above, the NSLCF 1450 may be selected at the NSLCFS 1420. Location information of the selected NSLCF 1450 may be set to an FF-CP 1430, and routing of an actual CP message may be performed at the FF-CP1430.

The aforementioned operations of FIG. 4 may be applicable as is to the functions of FIG. 14 and thus, a further description is omitted.

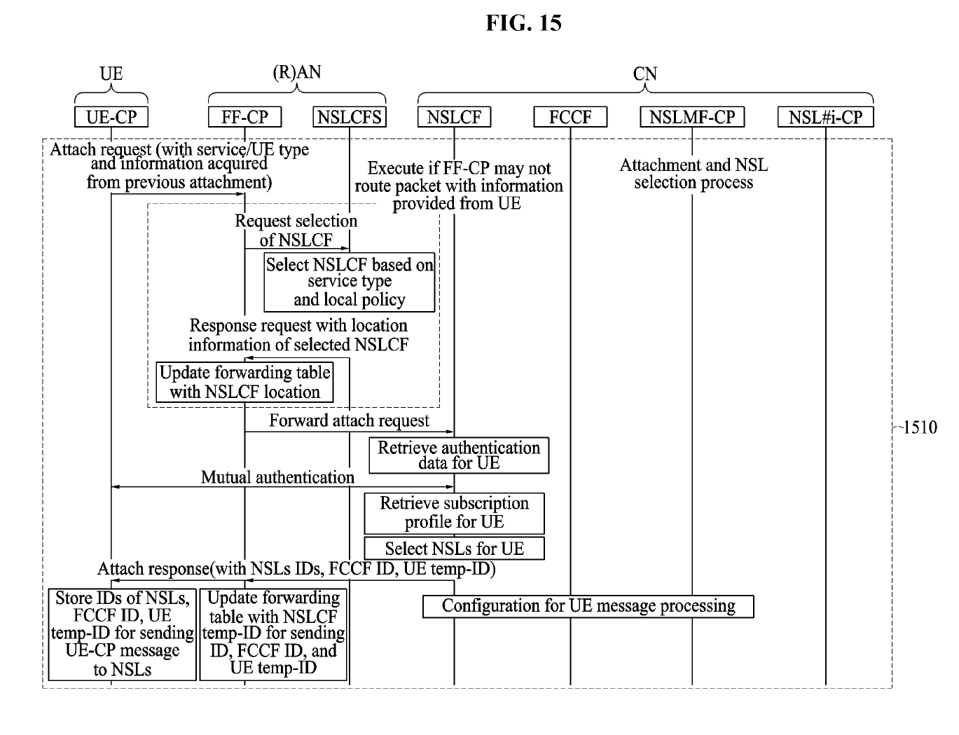

FIG. 15 illustrates an initial attachment procedure in the functional architecture of FIG. 14 according to an example embodiment.

FIG. 15 illustrates a procedure of performing an initial attachment to a network slice using the aforementioned function deployment and the added two functions, for example, an NSLCFS and an FF.

An area 1510 indicated with dotted lines may be executed when an FF-CP does not indentify the NSLCF with the information provided by a UE from a forwarding table. That is, the area 1510 may be executed when the FF-CP is incapable of routing a packet using only information provided from the UE. In this case, the FF-CP may transfer a CP message received from the UE to the NSLCFS so that an appropriate NSLCF may be selected. The NSLCFS may select the NSLCF based on a service type and a local policy. The NSLCFS may transfer a selection result, for example, location information of the selected NSLCF, to the FF-CP. The FF-CP may update the forwarding table with the selection result. The FF-CP may forward an attach request to the selected NSLCF.

When the FF-CP is capable of routing a packet using only information provided from the UE, the area 1510 may be omitted.

The following process is the same as the description of FIG. 5 and thus, a further description is omitted. The FF-CP may prepare the later routing for a user packet that includes all of the control plane and the user plane by updating the forwarding table based on an NSLCF ID, an FCCF ID, and a temporary ID of the UE.

FIG. 15 illustrates a procedure of updating the routing table using an attach response sent from the NSLCF to the UE-CP. The example embodiment may also be applicable to a case in which the NSLCF directly sends a message for updating corresponding information to the FF.

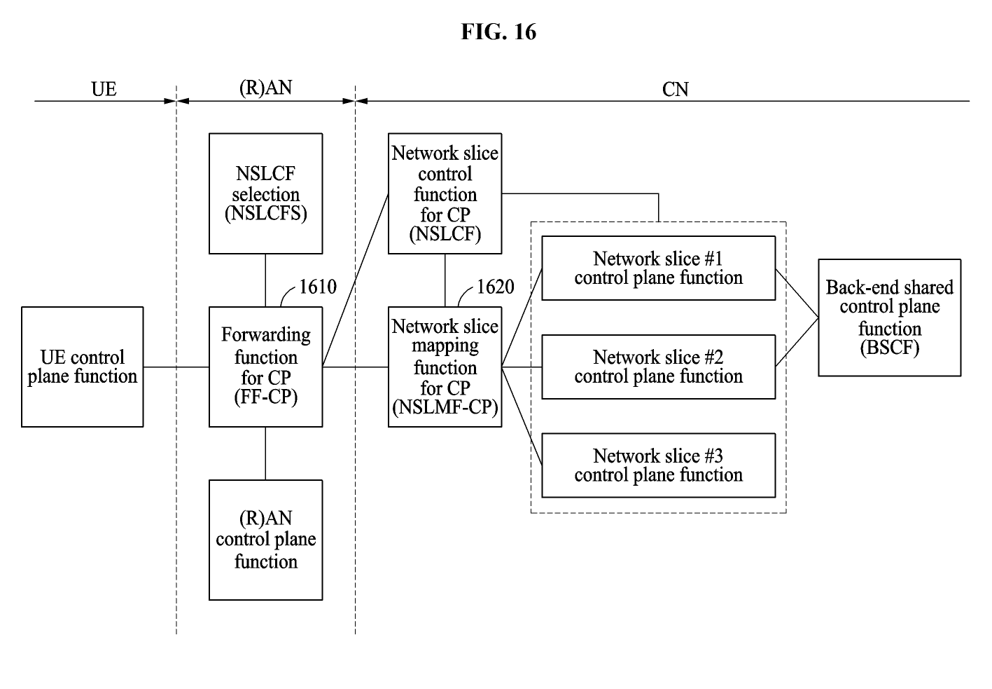

FIG. 16 is a diagram illustrating an example of a functional architecture when the functions of FIG. 8 are deployed in a network system according to an example embodiment.

FIG. 16 illustrates a function deployment when the FCCF of FIG. 14 is absent. An NSLMF-CP1620 may be deployed in a CN and an FF-CP1610 may request the NSLMF-CP1620 for information used to route a packet. Except that an ID of the NSLMF-CP1620 is used instead of using an ID of the FCCF and the FCCF is absent, the example embodiment of FIG. 16 is the same as FIG. 14 and thus, a further description is omitted.

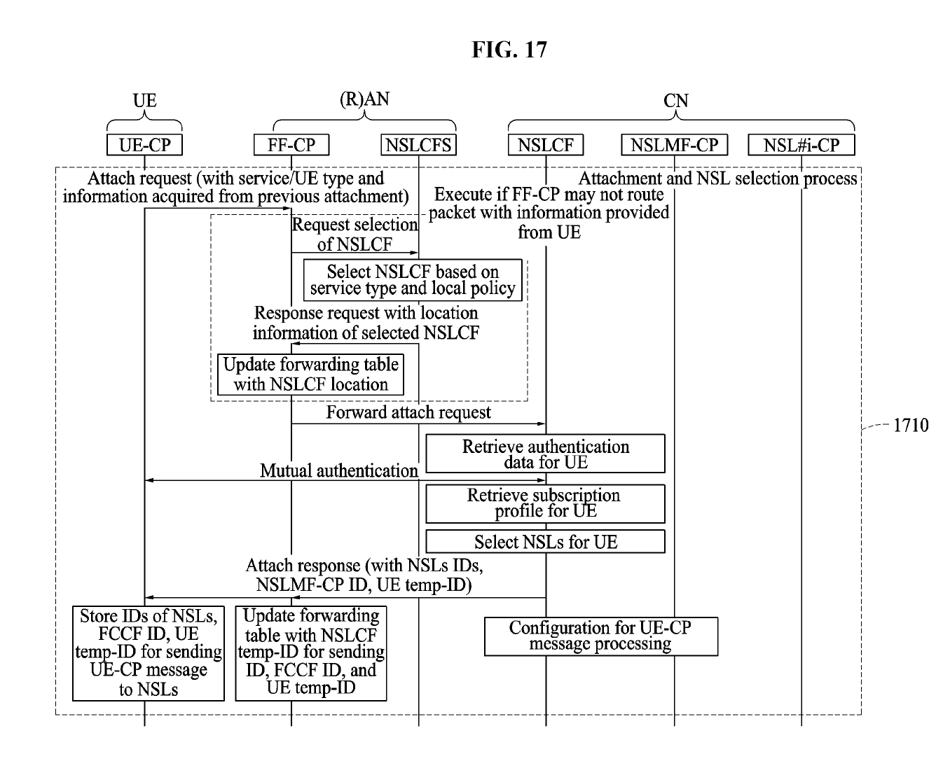

FIG. 17 illustrates an initial attachment procedure in the functional architecture of FIG. 16 according to an example embodiment.

The aforementioned operations of FIG. 15 may be applicable to an attachment and network slice selection process 1710 except that an FCCF is absent. Accordingly, a further description is omitted.

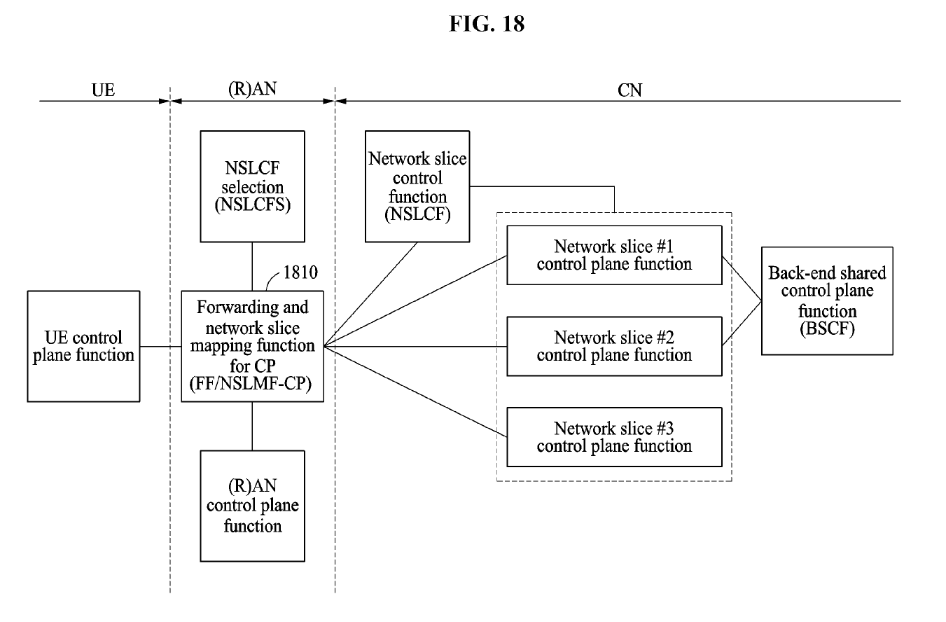

FIG. 18 is a diagram illustrating another example of a functional architecture when the functions of FIG. 8 are deployed in a network system according to an example embodiment.

The function deployment of FIG. 18 is the same as that of FIG. 15 except that an NSLMF is deployed in a (R)AN. That is, the NSLMF may be deployed in the (R)AN as an FF/NSLMF-CP1810. Accordingly, routing information to transfer to an NSLMF-CP is not required. That is, the NSLMF-CP may be installed for each (R)AN so that the (R)AN may directly switch to a network slice of a CN.

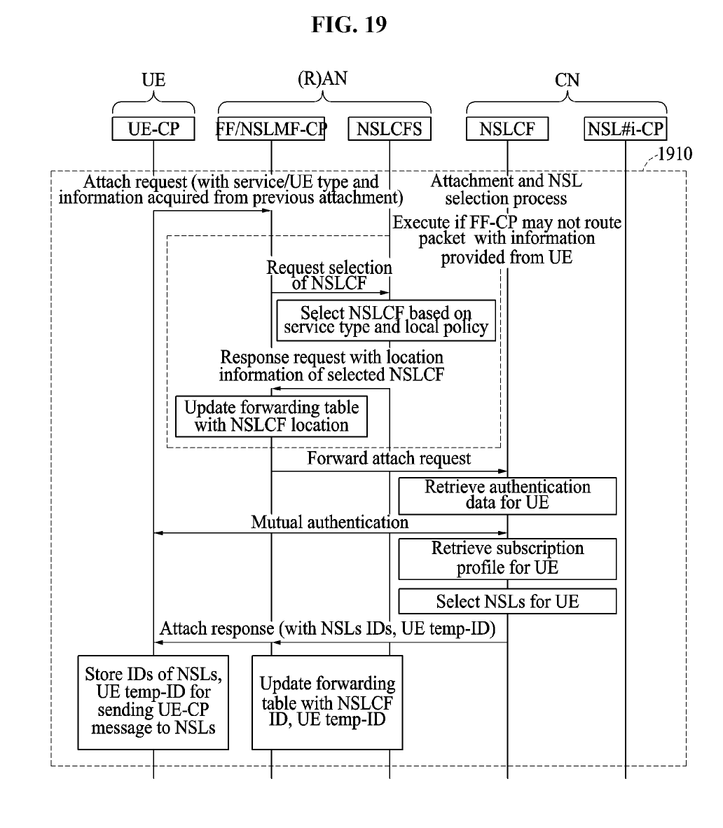

FIG. 19 illustrates an initial attachment procedure in the functional architecture of FIG. 18 according to an example embodiment.

An attachment and network slice selection process 1910 is the same as that of FIG. 17 except that an NSLMF is deployed in a (R)AN as an FF/NSLMF-CP. Thus, a further description is omitted.

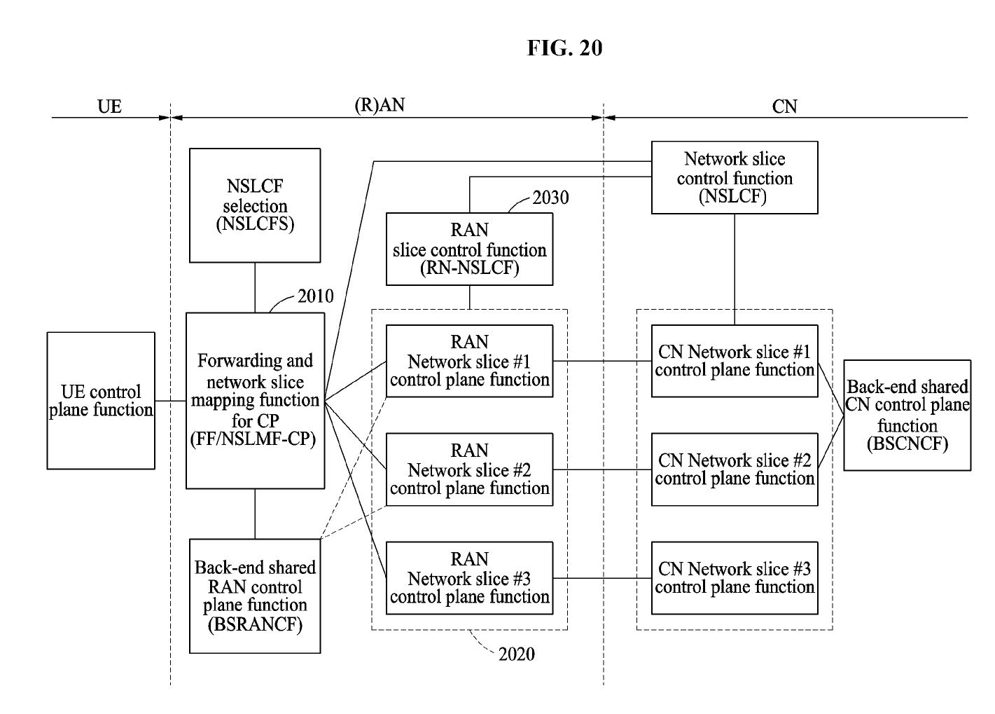

FIG. 20 is a diagram illustrating another example of a functional architecture when the functions of FIG. 8 are deployed in a network system according to an example embodiment.

A function deployment of FIG. 20 corresponds to a case in which an NSLMF is deployed in a (R)AN as an FF/NSLMF-CP 2010 and a network slice 2020 is also configured in the RAN. In this case, a RAN network slice control plane function

(RN-NSLCF) 2030 may be defined to control the network slice 2020 of the RAN area. The aforementioned operations may be applicable to the remaining functions and thus, a further description is omitted.

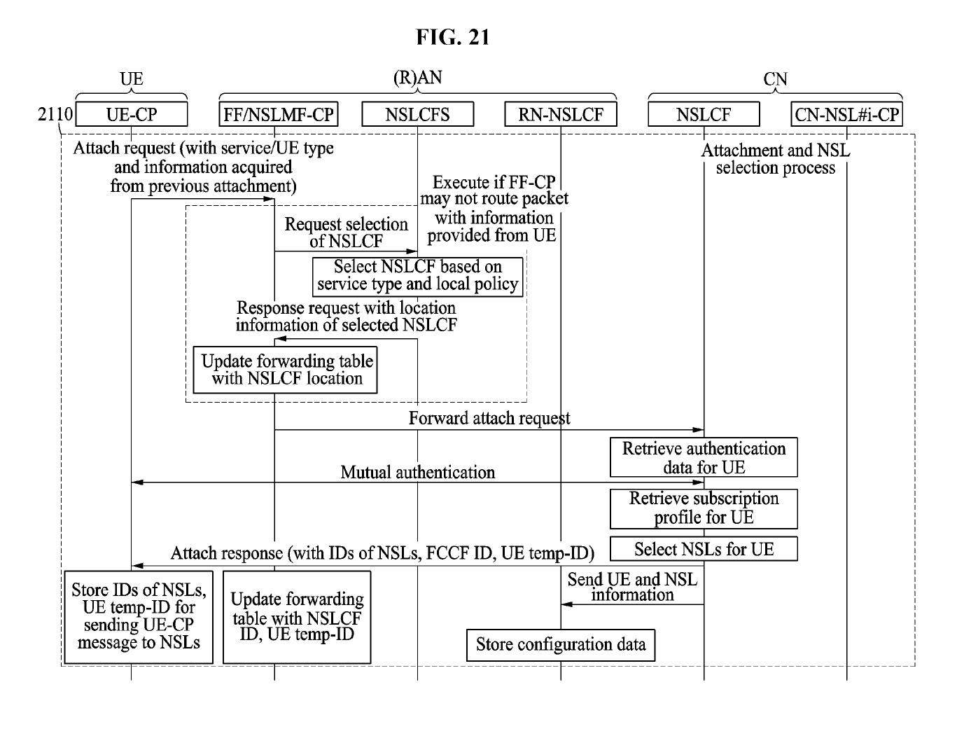

FIG. 21 illustrates an initial attachment procedure in the functional architecture of FIG. 20 according to an example embodiment.

In the case of an attachment and network slice selection process 2110, network slice selection related information may be transferred from an NSLCF to an RN-NSLCF after network slice selection, so that a network slice of a (R)AN area may be controlled.

That is, after the network slice selection for a UE, the NSLCF may send information about network slices and the UE to the RN-NSLCF. The RN-NSLCF may store configuration data.

The aforementioned description of FIG. 19 may be applicable to other operations.

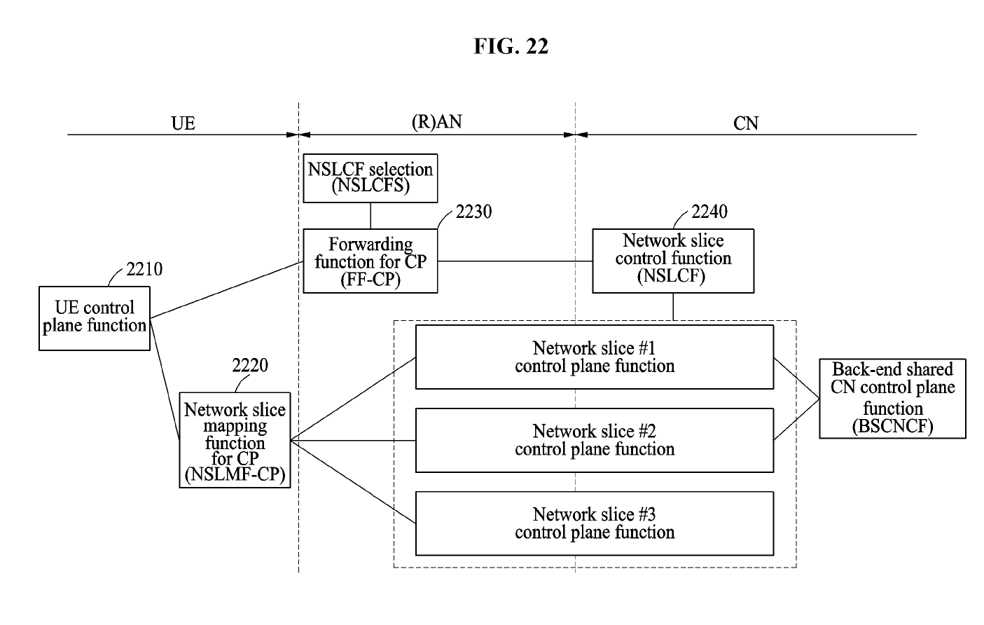

FIG. 22 is a diagram illustrating another example of a functional architecture when the functions of FIG. 8 are deployed in a network system according to an example embodiment.

A function deployment of FIG. 22 corresponds to a case in which an NSLMF-CP 2220 is deployed in a UE. Since the NSLMF-CP 2220 is deployed in the UE, IDs of network slices determined at an NSLCF 2240 and a temporary ID of the UE may be sent to a LTE-CP 2210 through an FF-CP 2230.

The UE-CP 2210 may update parameters associated with the NSLMF-CP 2220 based on the IDs of the network slices and the temporary ID of the UE. Through this, messages occurring in the UE may be transferred to a corresponding network slice through the NSLMF-CP 2220. The aforementioned description of FIG. 20 may be applicable to the remaining functions and thus, a further detailed description is omitted.

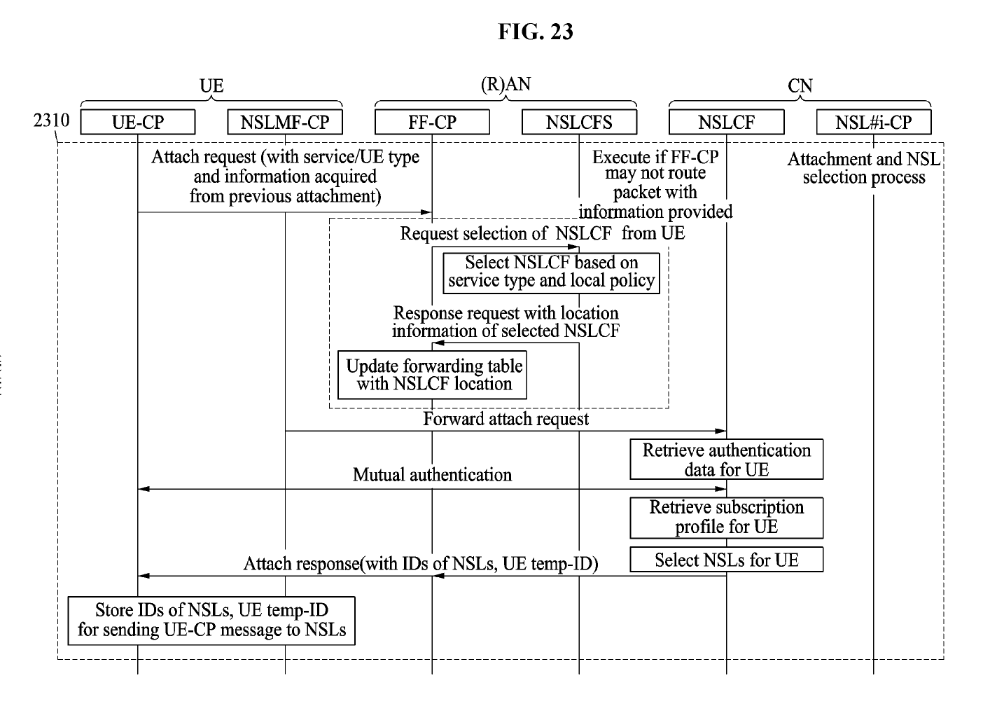

FIG. 23 illustrates an initial attachment procedure in the functional architecture of FIG. 22 according to an example embodiment.

The aforementioned operations may be applicable to an attachment and network slice selection process 2310 except that a NSLMF-CP is deployed in a UE.

A function deployment for a network slice operation on a control plane is described. Hereinafter, a function deployment for the network slice operation on a user plane will be described.

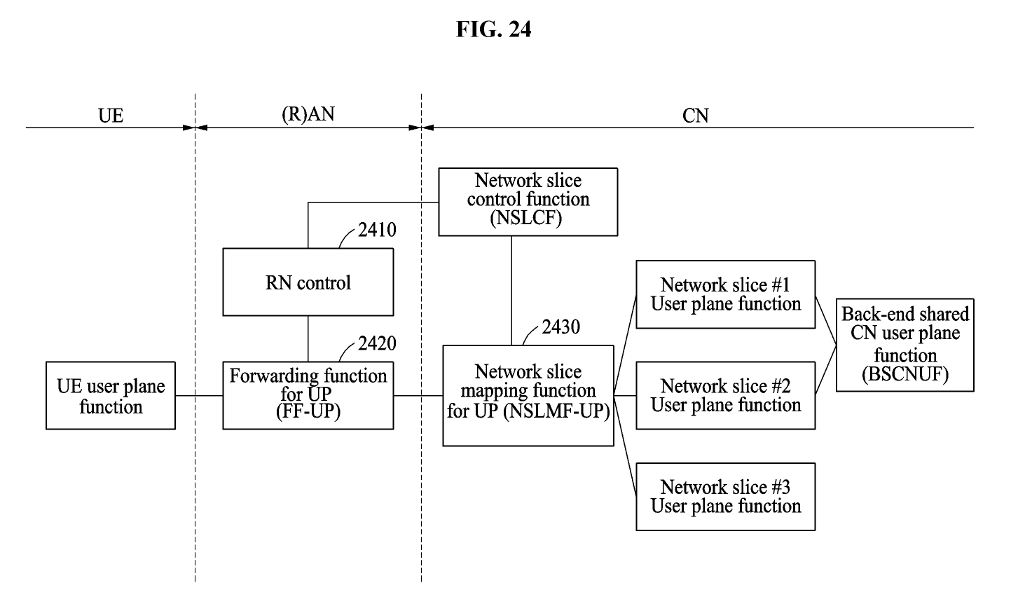

FIG. 24 is a diagram illustrating an example of a functional architecture when the functions of FIG. 12 are deployed in a network system according to an example embodiment.

FIG. 24 illustrates a case in which an NSLMF-UP 2430 is deployed in a CN. Since the NSLMF-UP 2430 is deployed in the CN, information for routing from a (R)AN to the NSLMF-UP 2430 needs to be recorded in an FF-UP 2420.

In the aforementioned control plane function, it is described that an FF-CP measures and monitors such information during an attach response being transferred from an NSLCF-CP to a UE-CP, and updates a forwarding table or a routing table. Also, since relevant information is transferred from an NSLCF through a separate RAN control, updating the forwarding table is not excluded.

FIG. 24 illustrates a function deployment when an RN control 2410 updates routing information of the FF-UP 2420. The aforementioned description may be applicable to remaining functions and thus, a further description is omitted.

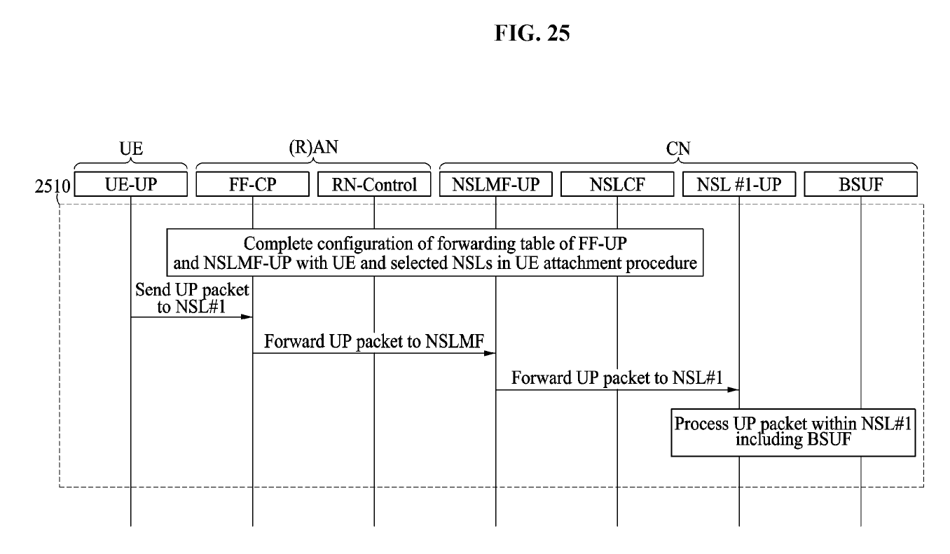

FIG. 25 illustrates a control plane (CP) packet processing procedure in the functional architecture of FIG. 24 according to an example embodiment.

FIG. 25 illustrates a network slice #1 UP packet processing 2510. In detail, a configuration of a forwarding table of an FF-UP and an NSLMF-UP may be performed at a UE and a selected network slice during a UE attachment procedure. An UE-UP may send, to the FF-UP, a packet that the UE-UP desires to send to the NSL #1. The FF-UP may forward the UP packet to the NSLMF-UP. The NSLMF-UP may forward the UP packet to the NSL #1. The UP packet may be processed in the BSUF and the NSL #1.

Here, routing information of the FF-UP may be configured during the attachment procedure.

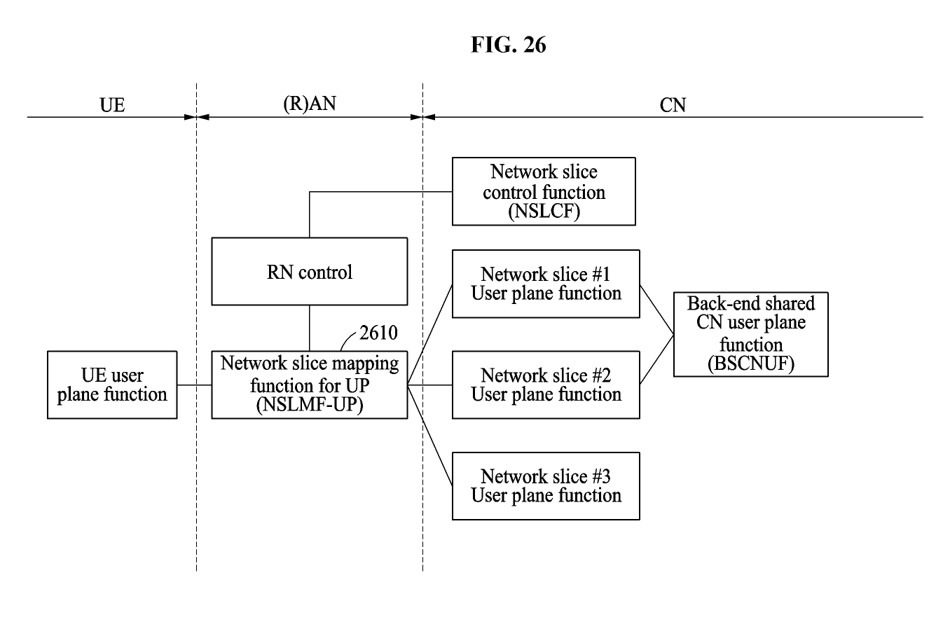

FIG. 26 illustrates another example of the functional architecture when the functions of FIG. 12 are deployed in the network system according to an example embodiment. A function deployment of FIG. 26 may correspond to a case in which an NSLMF-UP 2610 is deployed in a (R)AN.

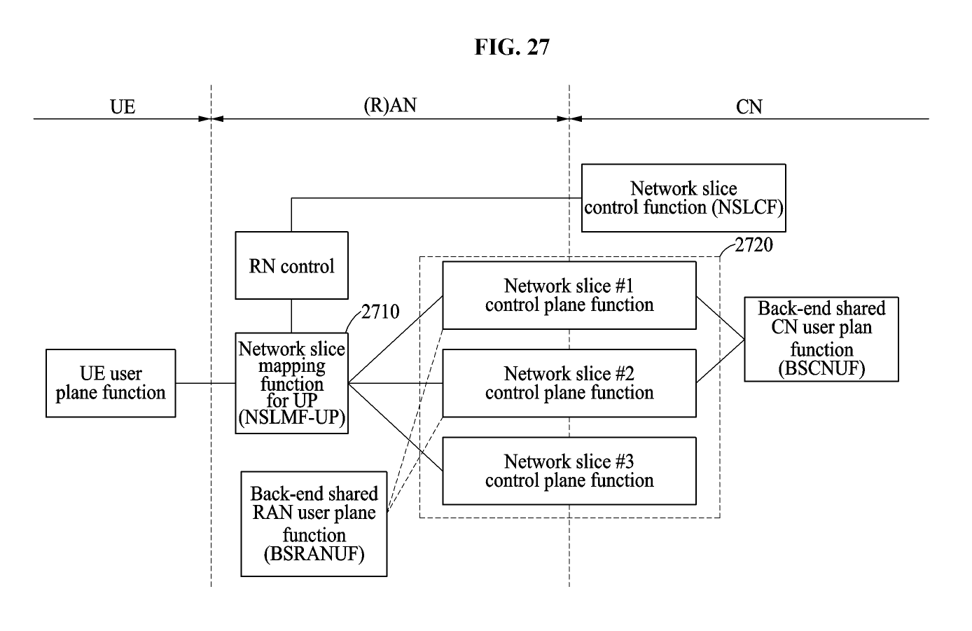

FIG. 27 illustrates another example of the functional architecture when the functions of FIG. 12 are deployed in the network system according to an example embodiment. A function deployment of FIG. 27 may correspond to a case in which an NSLMF-UP 2710 is deployed in a (R)AN and a network slice 2720 is expanded to the (R)AN.

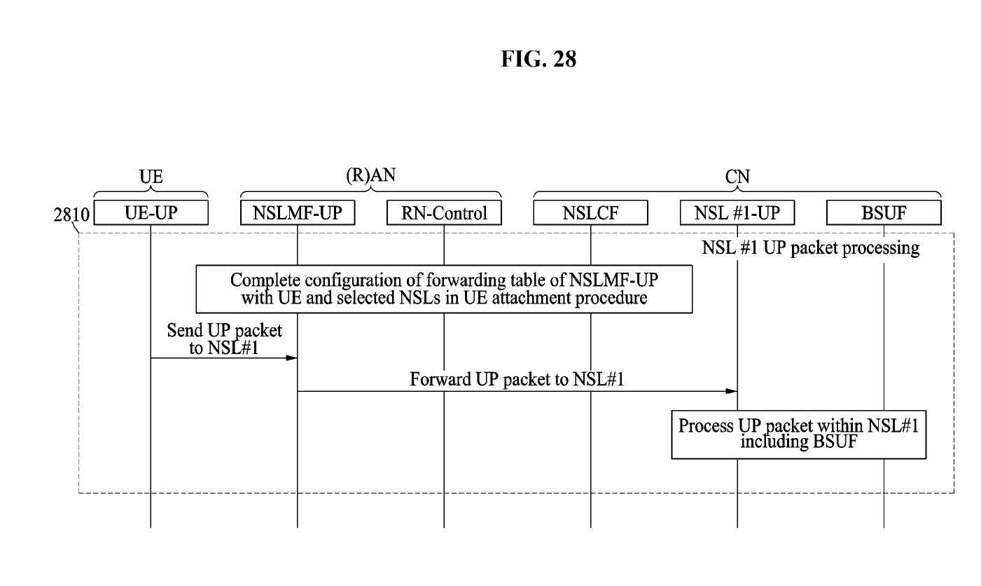

FIG. 28 illustrates a CP packet processing procedure in the functional architecture of FIG. 26 or 27 according to an example embodiment.

A network slice #1 UP packet processing 2810 of FIG. 28 may represent the UP data/packet processing procedure in the function deployment of FIGS. 26 and 27. Here, an NSLMF-UP may perform a function of transferring UP data/packet to a corresponding network slice.

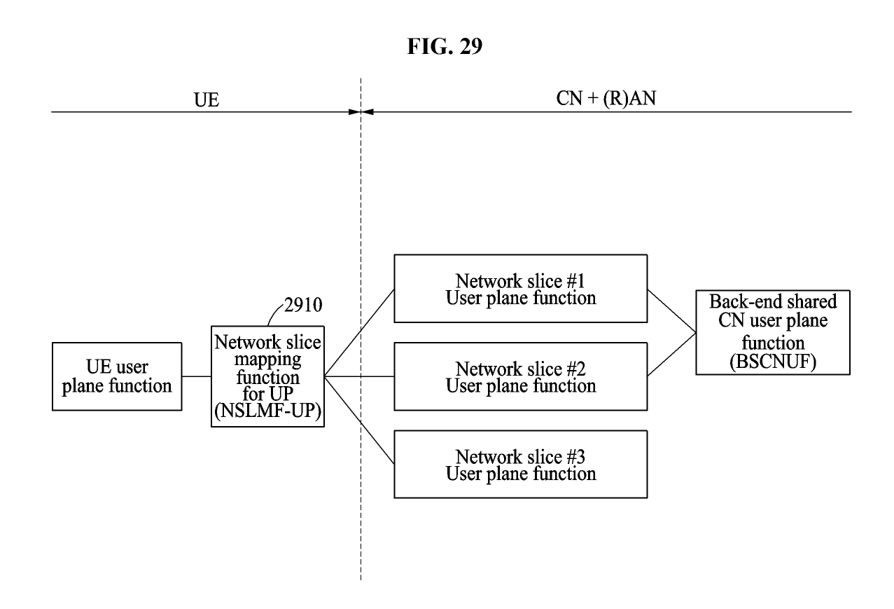

FIG. 29 illustrates another example of the functional architecture when the functions of FIG. 12 are deployed in the network system according to an example embodiment.

A function deployment of FIG. 29 may correspond to a case in which an NSLMF-UP 2910 is deployed in a UE. For example, the function deployment of FIG. 29 may be applicable to a case in which the UE corresponds to a dedicated terminal of a specific network slice.

The aforementioned description may be applicable to remaining functions and thus, a further description is omitted.

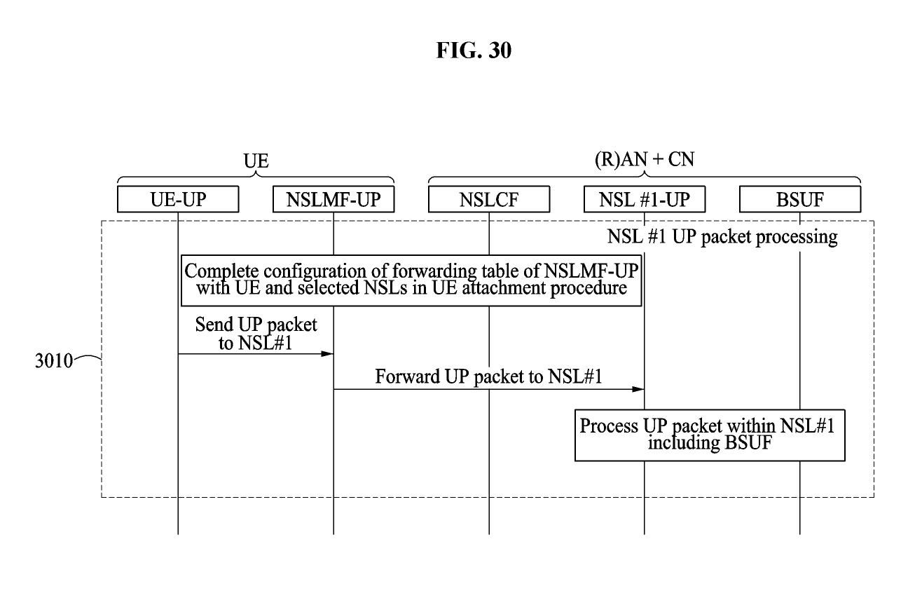

FIG. 30 illustrates a CP packet processing procedure in the functional architecture of FIG. 29 according to an example embodiment.

A basic operation of network slice #1 UP packet processing 3010 is the same as above except that an NSLMF-UP is installed in a UE. Accordingly, a further detailed description is omitted.

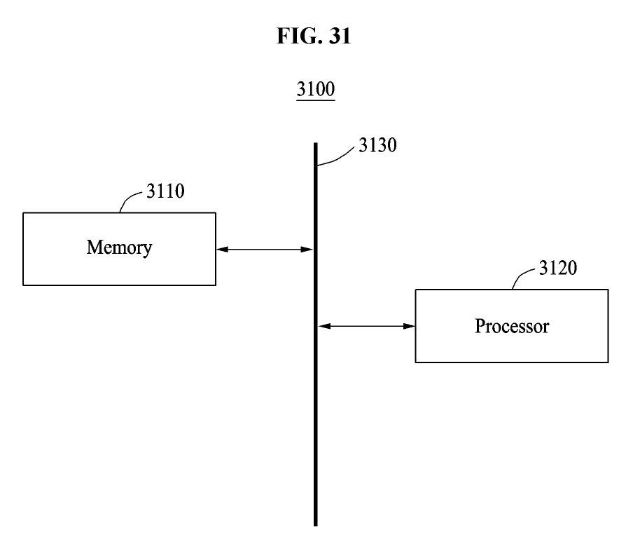

FIG. 31 is a block diagram illustrating an communication pparatus to perform communication according to an example embodiment.

Referring to FIG. 31, a communication apparatus 3100 includes a memory 3110 and a processor 3120. The memory 3110 and the processor 3120 may communicate with each other through a bus 3130.

The memory 3110 may include computer-readable instructions. The processor 3120 may perform the aforementioned operations in response to an instruction stored in the memory 3110 being executed at the processor 3120. The memory 3110 may be a volatile memory or a nonvolatile memory.

The processor 3120 may execute instructions or programs, or may control the communication apparatus 3100. The communication apparatus 3100 may be configured as a portion of various computing devices. In addition, the communication apparatus 3100 may perform the aforementioned operations.

The processor 3120 may perform communication on a control plane of a network system including an AN and a CN, may receive an attach request from a UE, may perform a mutual authentication with the UE in response to the attach request, may retrieve a subscription profile for the UE in response to the attach request when the mutual authentication is completed, and may determine a network slice for the UE based on the subscription profile.

Here, the network slice may include at least one virtualized network function for providing an end-to-end network service to the UE.

The attach request may include information about a type of a service that the UE desires to use and a characteristic of the UE. Information about the type of the service may include information about at least one of a service type the UE desires to use, an application service identifier, and a data network name to be connected, and a network slice previously attached to by the UE. The subscription profile may include information about a network slice allowed to the UE.

Also, the communication apparatus 3100 may transfer an ID of the determined network slice and a temporary ID of the UE to the UE.

Also, the communication apparatus 3100 may transfer an ID of the determined network slice and a temporary ID of the UE to an NSLMF-CP.

Also, the processor 3120 that performs communication on the control plane of the network system including the AN and the CN may receive a new service request from the UE, may retrieve a subscription profile for the UE in response to the new service request, may add a new network slice or change an existing network slice with the new network slice based on the subscription profile, and may transfer an ID of the new network slice to the UE.

Also, the processor 3120 that performs communication on the control plane of the network system including the AN and the CN may determine a detachment procedure based on the type of the service used at the UE, and a network context and policy, may perform a detachment of the UE from a network slice used at the UE according to the detachment procedure, and may perform a detachment of the UE from an NSLMF according to the detachment procedure when the detachment procedure is completed at the network slice.

Also, the processor 3120 that performs communication on a user plane of the network system including the AN and the CN may receive a UP packet from the UE, may map a corresponding network slice to the UP packet, may transfer the UP packet to the network slice, and may process the UP packet through the network slice.

The aforementioned matters with FIGS. 1 through 30 may be applicable to the components of FIG. 31 and thus, a further description is omitted.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the exemplary embodiments of the present invention may be achieved by hardware components including at least one DSP

(Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method on a control plane of a network system comprising an access network and a core network, the communication method comprising:
receiving an attach request from a user equipment;
performing a mutual authentication with the user equipment in response to the attach request;
retrieving a subscription profile for the user equipment in response to the attach request, when the mutual authentication is completed; and
determining a network slice for the user equipment based on the subscription profile.

2. The communication method of claim 1, wherein the network slice includes at least one virtualized network function for providing an end-to-end network service to the user equipment.

3. The communication method of claim 1, wherein the attach request includes information about a type of a service the user equipment desires to use and a capability of the user equipment, or a context in which a user equipment resides.

4. The communication method of claim 3, wherein information about the type of the service includes information about at least one of a service type the user equipment desires to use, an application service identifier, and a data network name to be connected, and a network slice previously attached to by the user equipment.

5. The communication method of claim 1, wherein the subscription profile includes information about a network slice allowed to the user equipment, and includes information about a default network slice when information about a type of a service the user equipment desires to use is not included in the attach request.

6. The communication method of claim 1, further comprising:
transferring an identifier of the determined network slice and a temporary identifier of the user equipment.

7. The communication method of claim 1, further comprising:
transferring an identifier of the determined network slice and a temporary identifier of the user equipment to a network slice mapping function for control plane (NSLMF-CP).

8. The communication method of claim 1, further comprising:
determining a front-end common control function (FCCF) appropriate for the user equipment based on at least one of a current status of the user equipment, a local status of the network system, and a network operator's policy on the network system.

9. The communication method of claim 1, further comprising:
determining a network slice control function (NSLCF) based on at least one of a service type and a local policy corresponding to the user equipment in response to the attach request, when the NSLCF is not identified at an access network having received the attach request;
updating a forwarding table with the determined NSLCF; and
transferring the attach request to the determined NSLCF using the forwarding table.

10. The communication method of claim 1, wherein a network slice mapping function (NSLMF) of determining a network slice instance to process a packet on the control plane transferred from the user equipment based on an identifier of the determined network slice is provided to one of the core network, the access network, and the user equipment.

11. The communication method of claim 1, further comprising:
receiving a control plane message, a temporary identifier of the user equipment, and an identifier of the network slice from the user equipment; and
determining a network slice instance to which the control plane message is to be transferred based on the temporary identifier of the user equipment and the identifier of the network slice.

12. The communication method of claim 1, further comprising:
receiving a new service request from a user equipment;
determining whether a currently selected network slice is capable of providing a corresponding service in response to the new service request;
retrieving a subscription profile for the user equipment in response to the new service request, when the corresponding service is not provided at the currently selected network slice;
adding a new network slice or changing the currently selected network slice with the new network slice based on the subscription profile; and
transferring an identifier of the new network slice to the user equipment.

13. The communication method of claim 12, wherein the changing comprises:
determining the new network slice within a range allowed by the subscription profile in response to the new service request; and
newly selecting a front-end common control function (FCCF) or a network slice mapping function (NSLMF) corresponding to the new network slice, and setting network slice information associated with the user equipment to the selected FCCF or NSLMF, and
the transferring comprises transferring the identifier of the newly selected network slice to the user equipment and further transferring an identifier of a changed FCCF or NSLMF in response to the change of the FCCF or the NSLMF.

14. The communication method of claim 12, further comprising:
recognizing a change of the subscription profile for the user equipment; and
paging the change of the subscription profile to the user equipment based on a recognition result.

15. The communication method of claim 1, further comprising:
determining a detachment procedure based on a type of a service used by a user equipment and a network context and policy;
detaching the user equipment from a network slice used by the user equipment according to the detachment procedure; and
deleting information about the user equipment according to the detachment procedure using a network slice mapping function (NSLMF), in response to the detachment procedure being completed at the network slice.

16. The communication method of claim 15, further comprising:
receiving a detach request from the user equipment;
deleting a network slice configuration for the user equipment from the control plane of the network system in response to the detach request; and
sending a response to the detach request to the user equipment in response to the network slice configuration being deleted.

17. The communication method of claim 15, further comprising:
recognizing a unnotified detachment of the user equipment or receiving a unilateral detachment from all of the network slices used by the user equipment; and
deleting a network slice configuration for the user equipment from the control plane of the network system in response to recognizing the arbitrarily detachment or receiving the unilateral detachment.

18. A communication method on a user plane of a network system comprising an access network and a core network, the communication method comprising:
receiving a user plane packet from a user equipment;
mapping a corresponding network slice to the user plane packet;
transferring the user plane packet to the network slice; and
processing the user plane packet through the network slice.

19. The communication method of claim 18, wherein the processing comprises:
processing the user plane packet by further using a back-end shared user plane function (BSUF), when the BSUF shared between a part of or all of the network slices is present.

20. A communication method of a network system comprising an access network and a core network, the communication method comprising:
providing a service on-demand by selecting a network slice appropriate to the service requested from a user equipment among network slices specified for each service;
configuring a service within the selected network slice to be optimized for a characteristic of the service or a user environment on the granularity of packet or service flow; and
creating a new network slice to provide the service or modifying an exisiting network slice when the service requested from the user is incapable of being satisfied through the exisiting network slice due to the limitation interms of performance or coverage,
wherein the network system comprises:
a network slice operation environment providing functional blocks that includes a network slice control apparatus and a plurality of network slices;
a virtualized resource configured to execute an operation environment of the network slice;
a network slice management function configured to manage a lifecycle of the network slice;
a virtualized resource management function configured to manage a lifecycle of the virtualized resource;
a network slice service orchestration function configured to orchestrate the network slice and to orchestrate a configuration of a resource;
a network slice service business support system/operation support system (BSS/OSS) function used for the network slice to provide a business support and a network slice operation management, and a business and operation management methods for the entire network slices to a network slice provider;
a network slice control portal function configured to enable the user equipment to manage a network slice; and
a network slice attachment for the user equipment.
